(19) United States
(12) Patent Application Publication
(10) Pub. No.: US 2016/0093166 A1
(43) Pub. Date: Mar. 31, 2016

(54) SYSTEM AND METHOD FOR WIRELESS CARD-IN/CARD-OUT

(71) Applicant: BALLY GAMING, INC., Las Vegas, CA (US)

(72) Inventors: Karthik Shenoy Panambur, Bangalore (IN); Yogendrasinh Hematji Rajput, Bangalore (IN); Prateek Kumar Baishkhiyar, Jharkhand (IN)

(73) Assignee: BALLY GAMING, INC., Las Vegas, CA (US)

(21) Appl. No.: 14/500,853

(22) Filed: Sep. 29, 2014

(51) Int. Cl. G07F 17/32; G06Q 20/32; G06Q 50/34; H04W 4/00

(52) U.S. Cl. CPC G07F 17/3251; H04W 4/005; H04W 4/008; G06Q 20/3278; G06Q 50/34; G06Q 20/3226

(57) ABSTRACT

A system configured to pair a mobile device with a terminal device, track interactions between the mobile device and the terminal device while paired, and un-pair the mobile device from the terminal device. The terminal device includes a touch screen terminal display and communication interface that communicates with a host server through a communication network. The host server has access to a database storing user accounts. The user mobile device includes a touch screen display and a wireless transceiver.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE DISCLOSURE

This disclosure relates to systems and methods of pairing of user mobile devices with gaming devices for tracking the interaction between the user and the terminal devices and, more specifically, to systems and methods of pairing of user mobile devices with gaming devices for providing for transfer of funds.

### BACKGROUND

Customer loyalty programs have been implemented in many types of businesses. Some examples include grocery stores, airlines, restaurants, pharmacies, and the like. In these examples, a user registers with the business and is issued a magnetic stripe, machine readable, loyalty card. When the user engages in a transaction with the business, they present their loyalty card (or reference their loyalty card if the transaction is on-line) to receive benefits, such as discounts, upgrades, and the like. The benefit to the card holder of using the loyalty card is the extra rewards provided by the loyalty card, as well as the potential receipt of occasional promotions from the business. The benefit to the business is that the business establishes a database of customers for marketing purposes, as well as instilling a degree of customer loyalty with the business.

In the field of gaming, particularly brick and mortar casino enterprise gaming, these loyalty programs are often referred to as player clubs. A player enrolls in the club by providing personal information which is saved in a player account file, stored at a server level, and associated with the player. The player is provided with a magnetic-striped player card. When a player plays a gaming device or table game they present their player card which is read (or referenced) and the player's gaming activity is tracked. Typically, the tracking results in the award of points representative of the player's wagering activity. The points earned can be redeemed by the player for benefits, e.g. “comps.” These comps may include meals, show tickets, cash back of other products and services. The player card cannot only be used to redeem points for goods or services as comps at a point-of-sale location (such as a restaurant or gift shop), but commercial activity by the player (such as purchases or hotel stays) can earn the player points to be redeemed as comps. Further, the points earned by the player provide the enterprise with a gauge of the worth of the player to the enterprise.

A drawback to loyalty or player cards is that they are subject to being lost or forgotten. Replacement requires staffing and the cost of carrying an inventory of blank cards to be issued as replacements. A further drawback is that, in casinos, players can intentionally or inadvertently leave their card in a gaming machine card reader. A new player at the machine, if they don't notice the existing card, wagers and plays the game resulting in points accruing to the now absent player owning the card.

Some casino enterprise gaming systems enable players to establish an electronic funds account and upload and download funds to and from the account from a gaming device, such as suggested in Weiss, U.S. Pat. No. 6,890,258 issued May 10, 2005 and titled “Cashless Gaming System: Apparatus and Method”, the disclosure of which is incorporated by reference. For example, a player may deposit funds in an electronic account, select a personal identification number (PIN), and then be issued a player card. The account may be accessed at a gaming machine via the player card and PIN to upload and download funds. The same drawbacks noted above with physical player cards apply to funds transfers as well. Replacement for lost cards represents an expense to the enterprise. Again, a drawback to this approach is that a physical player card is subject to being lost or forgotten.

It would be useful if a system could be provided which enables the transfer of funds to a player without the above described drawbacks.

### SUMMARY

Briefly, and in general terms, disclosed herein is a system configured to pair a mobile device with a terminal device, track interactions between the mobile device and the terminal device while paired, and un-pair the mobile device from the terminal device. The terminal device includes a touch screen terminal display and communication interface that communicates with a host server through a communication network. The host server has access to a database storing user accounts. The user mobile device includes a touch screen display and a wireless transceiver.

The system includes a terminal device transceiver associated with each terminal device, at least one of the terminal device transceiver and the mobile device transceiver configured to broadcast a beacon signal to acquire a response and establish a wireless communication link between the mobile device and the terminal device, and at least one of the terminal device transceiver and the mobile device transceiver configured to determine the signal strength of the wireless communication link established between the mobile device and terminal device. The system also includes a processor and associated memory device with each terminal device configured to determine from the signal strength: (1) a first range between the terminal device and mobile device indicative of a user mobile device pairing with the terminal device and upon successful pairing, (2) a second range outside of the first range indicative of continued user mobile device presence at the terminal device which maintains continued pairing with the terminal device, and (3) a third range outside of the second range indicative of the mobile device having left the terminal device whereupon the processor un-pairs the mobile device from the terminal device. Additionally, the terminal device is configured to access the user's account through the network and provide data to and/or from the user's account and the host server based upon the user's interaction with the terminal device during pairing.

In another embodiment, a gaming machine is disclosed that includes a touch screen video display and network link to communicate with a host server and provide data related to player activity at the gaming machine. The gaming machine includes a communication device configured to broadcast a beacon signal to detect a mobile device transceiver, acquire a response to establish a communication link between the mobile device and the gaming machine, and determine the signal strength of the communication link. The gaming machine also includes a processor and associated memory device configured to determine from the signal strength: (1) a first range between the gaming machine and mobile device, indicative of a player pairing their mobile device with the gaming machine, (2) a second range outside of the first range, indicative of continued user mobile device presence at the gaming machine, which maintains continued pairing with the gaming machine, and (3) a third range outside of the second range, indicative of the mobile device having left the gaming machine, whereupon the processor un-pairs the mobile device from the gaming machine. Additionally, the gaming machine provides the data to the host server based upon the player's activity at the gaming machine while paired with the mobile device.

In another embodiment, a method is disclosed to pair a mobile device with a gaming machine and track interactions between the mobile device and the gaming machine while paired. The method includes: providing the gaming machine including a touch screen video display and network link to communicate with a host server to provide data related to player activity at the gaming machine; broadcasting a beacon signal from a communication device to detect a mobile device transceiver; acquiring a response to establish a communication link between the mobile device and the gaming machine; determining the signal strength of the communication link; determining from the signal strength, using a processor and associated memory device, a first range between the gaming machine and mobile device, indicative of a player pairing their mobile device with the gaming machine; determining from the signal strength, using the processor and the associated memory device, a second range outside of the first range, indicative of continued user mobile device presence at the gaming machine, which maintains continued pairing with the gaming machine, and determining from the signal strength, using the processor and the associated memory device, a third range outside of the second range, indicative of the mobile device having left the gaming machine, whereupon the processor un-pairs the mobile device from the gaming machine; wherein the gaming machine provides the data to the host server based upon the player's activity at the gaming machine while paired with the mobile device.

The disclosed embodiments further relate to machine readable media on which are stored embodiments of the disclosed invention described herein. It is contemplated that any media (e.g., memory device) suitable for retrieving instructions is within the scope of the disclosed embodiments. By way of example, such media may take the form of magnetic, optical, or semiconductor media. The invention also relates to data structures that contain embodiments of the disclosed invention, and to the transmission of data structures containing embodiments of the disclosed invention.

Further advantages of the disclosed embodiments will be brought out in the following portions of the specification, wherein the detailed description is for the purpose of fully disclosing the various embodiments without placing limitations thereon.

### BRIEF DESCRIPTION OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates a front perspective view of the player-sensing area and card-in area around a gaming machine.

FIG. 2 illustrates a front perspective view of the player-sensing area and card-in area around a gaming machine with a player “carding-in.”

FIG. 3 illustrates a front perspective view of a gaming machine and a smartphone in the “carding-in” process with the gaming machine displaying a prompt for pass-key and the mobile device displaying the pass-key.

FIG. 4 illustrates a front perspective view of a gaming machine and a smartphone during game play.

FIG. 5 illustrates a front perspective view of the player-sensing area and card-in area around a gaming machine with a player “carding-out.”

FIG. 6 illustrates a front perspective view of a gaming machine and a smartphone during the “Funds-Transfer” process.

FIG. 7 illustrates a front perspective view of a gaming machine and a smartphone during the “Funds-Transfer” process with the gaming machine displaying a prompt for pass-key and the mobile device displaying the pass-key.

FIG. 8 illustrates a front perspective view of a gaming machine and a smartphone with the “Funds-Transfer” process completed.

FIG. 9 illustrates a schematic diagram of an antenna for use with the wireless-enabled player-sensing and card-in system.

FIG. 10 illustrates a diagram of a wireless-enabled server and multiple wireless-enabled gaming machines in use with the wireless-enabled player-sensing and card-in system.

FIG. 11 illustrates a logic diagram of the wireless-enabled player-sensing and card-in system with the gaming machine as the master and the smartphone as the slave.

FIG. 12 illustrates a logic diagram of the wireless-enabled player-sensing and card-in system with the smartphone as the master and the gaming machine as the slave.

FIG. 13 illustrates a logic diagram of the wireless-enabled player-sensing and card-in system with the gaming machine and the smartphone in a role interchangeable mode.

FIG. 14 illustrates a logic diagram of the wireless-enabled player-sensing and card-in system with the funds transfer from the smartphone to the gaming machine/iView.

FIG. 15 illustrates a logic diagram of the wireless-enabled player-sensing and card-in system with the funds transfer from the smartphone to the gaming machine/iView to the mobile wallet.

FIG. 16 illustrates a perspective view of a gaming machine in accordance with one or more embodiments.

FIG. 17A illustrates a block diagram of the physical and logical components of the gaming machine of FIG. 16 in accordance with one or more embodiments.

FIG. 17B illustrates a block diagram of the physical and logical components of the gaming machine of FIG. 16 in accordance with one or more embodiments.

FIG. 18 illustrates a block diagram of the logical components of a gaming kernel in accordance with one or more embodiments.

FIG. 19A illustrates a schematic block diagram showing the hardware elements of a networked gaming system in accordance with one or more embodiments.

FIG. 19B illustrates a schematic block diagram showing the hardware elements of a networked gaming system in accordance with one or more embodiments.

FIG. 20 illustrates a diagram showing an example of architecture for tying a casino enterprise network to an external provider of games and content to Internet or broadband communication capable devices.

### DETAILED DESCRIPTION

Persons of ordinary skill in the art will understand that the present disclosure is illustrative only and not in any way limiting. Other embodiments of the presently disclosed system and method readily suggest themselves to such skilled persons having the benefit of this disclosure.

Each of the features and teachings disclosed herein can be utilized separately or in conjunction with other features and teachings to provide a system and method to provide user-configurable rules for team play on a single gaming machine. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “configuring,” “determining,” “displaying,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present application also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms presented herein are not inherently related to any particular computer or other apparatus. Various general purpose systems, computer servers, or personal computers may be used with programs in accordance with the teachings herein, or it may prove convenient to construct a more specialized apparatus to perform the required method steps. The required structure for a variety of these systems will appear from the description below. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

In one embodiment of the wireless-enabled player-sensing and card-in system, a player may enroll in a loyalty program using their wireless communication enabled mobile device, such that the player may use their mobile device to pair with a terminal device (e.g., a gaming terminal) for the purpose of having their game play tracked to earn points. In another embodiment of the wireless-enabled player-sensing and card-in system, an unregistered player may pair their mobile device with a gaming terminal, engage in game play, and earn anonymous points. Later this unregistered player may enroll in a loyalty program using their mobile device, whereupon the previously earned anonymous points may be allocated to the player's established account.

In still another embodiment of the wireless-enabled player-sensing and card-in system, the system may automatically “pair” the player's mobile device to the terminal, for tracking based upon factors include the range of the player's mobile device to the terminal, and “unpair” the mobile device and terminal to discontinue tracking In yet another embodiment of the wireless-enabled player-sensing and card-in system, the system may discriminate between situations where the player is still at the terminal but has re-positioned their mobile device in a purse or pocket so that tracking of the player can continue. Additionally, in another embodiment of the wireless-enabled player-sensing and card-in system, the system may discern which one of several nearby mobile devices is to be paired with the terminal for tracking.

In one embodiment of the wireless-enabled player-sensing and card-in system, the wireless technology implemented in the system is the Bluetooth standard. Bluetooth is a wireless technology standard for exchanging data over short distances (using short-wavelength UHF radio waves in the ISM band from 2.4 to 2.485 GHz) from fixed and mobile devices.

Every single Bluetooth device has a unique 48-bit address, commonly abbreviated BDDR. This address is usually presented in the form of a 12-digit hexadecimal value. The most-significant half (24 bits) of the address is an organization unique identifier (OUI), which identifies the manufacturer. The lower 24-bits are the more unique part of the address.

Received signal strength indicator (RSSI) is a measurement of the power present in a received radio signal. In this context, RSSI indicates the power of the Bluetooth signal received by the receiver. Using RSSI, the wireless-enabled player-sensing and card-in system can determine how far the Bluetooth-enabled devices are from each other. In some embodiments of the wireless-enabled player-sensing and card-in system, RSSI is responsible for successful card-in and card-out. RSSI values may be determined experimentally for card-in and car-out to set the threshold values for card-in and card-out. In one embodiment, the threshold for card-in and card-out are different so as to overcome the issue of unintentional card-out.

Referring now to the Connection Process, creating a Bluetooth connection between two devices is a multi-step process involving three progressive states: inquiry (discovery), paging (connecting), and pairing. During the inquiry step of the connection process, if two Bluetooth devices know absolutely nothing about each other, one must run an inquiry to try to discover the other. One device sends out the inquiry request, and any device listening for such a request responds with its address, as well as possibly its name and other information. During the paging (connecting) step of the connection process, a connection is formed between two Bluetooth devices. Before this connection can be initiated, each device needs to know the address of the other (found in the inquiry process). After a device has completed the paging process, it enters the connection state. While connected, a device can either be actively participating or it can be put into a low power sleep mode. During the pairing step, when two Bluetooth devices share a special affinity for each other, they can be paired together. Paired devices automatically establish a connection whenever the devices are close enough to each other.

When devices pair up, the devices share their addresses, names, and profiles, and usually store them in memory. They also share a common secret key, which allows them to bond whenever they're together in the future. Pairing usually requires an authentication process where a user must validate the connection between devices. The pairing processes involve the entering of a common PIN code on each device. The PIN code can range in length and complexity from four numbers (e.g. “0000” or “1234”) to a 16-character alphanumeric string.

Bluetooth profiles are additional protocols that build upon the basic Bluetooth standard to more clearly define what kind of data a Bluetooth module is transmitting. The one or more profiles a Bluetooth device supports determine what application the device is geared towards. A hands-free Bluetooth headset, for example, uses a headset profile (HSP), while a Nintendo Wii Controller implements the human interface device (HID) profile. For two Bluetooth devices to be compatible, they must support the same profiles.

Bluetooth is a packet-based protocol with a master-slave structure. The Bluetooth Core Specification provides for the connection of two or more devices, in which a certain device plays the master role and the other device plays the slave role. At any given time, data can be transferred between the master device and one other device. The master device chooses which slave device to address. Typically, the master device switches rapidly from one device to another in a round-robin fashion. Since it is the master device that chooses which slave device to address (whereas a slave device is (in theory) supposed to listen in each receive slot), being a master device is a lighter processor burden than being a slave device. Accordingly, being a master device of more than one slave device is possible; while being a slave device of more than one master device is difficult.

The HCI provides a command interface to the baseband controller and link manager, and access to configuration parameters. For the HC-05 module, various HCI commands are used called AT-Commands. The AT-Commands being used in these embodiments of the system are mostly for putting a device into a Master/Slave Role, putting the device in Inquiry mode (AT+INQ), connecting to device (AT+ADDR), and the like.

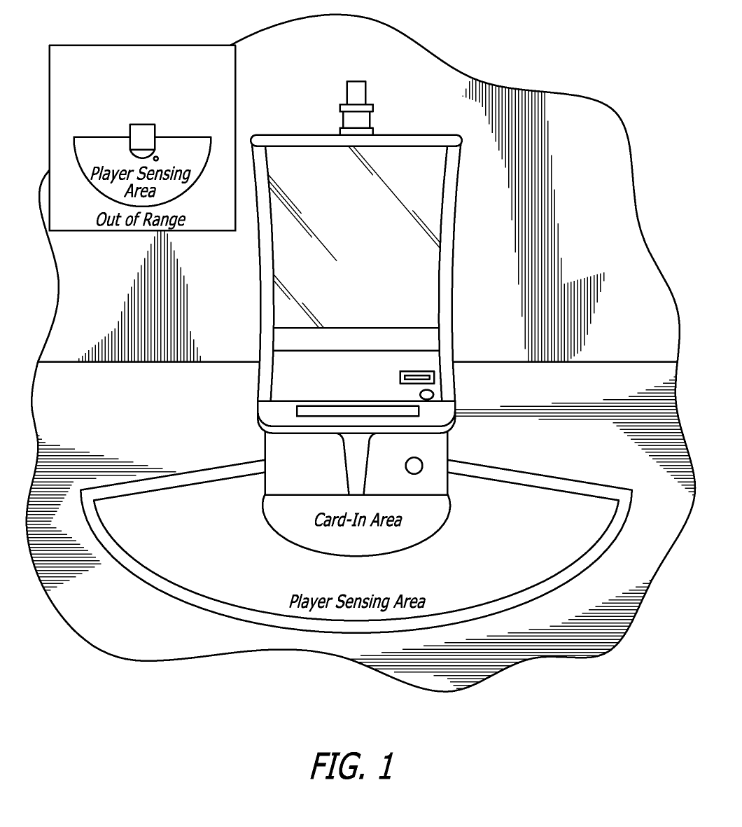

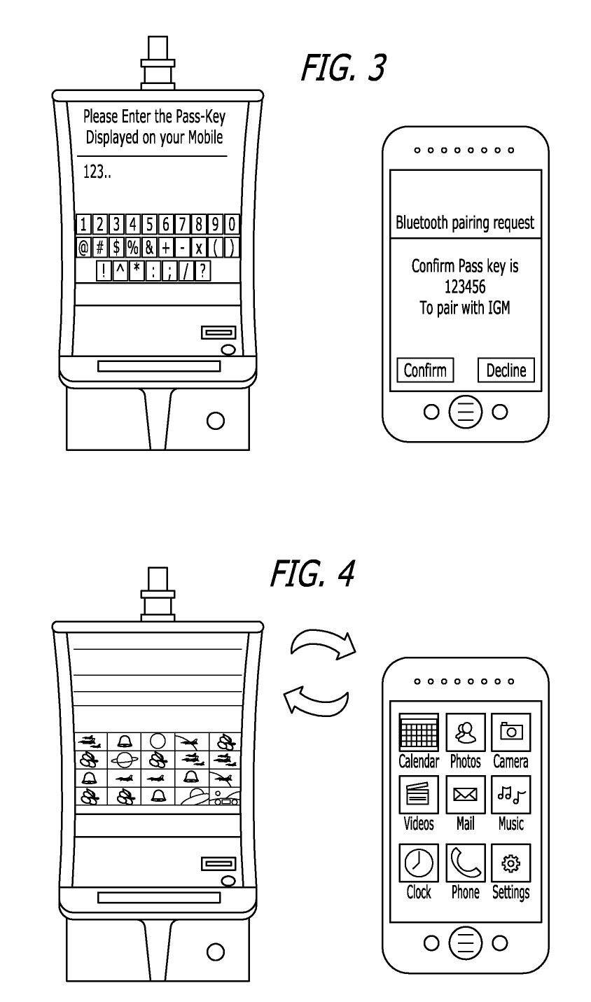

FIGS. 1-15 illustrate various embodiments of the disclosed system and method for wireless-enabled player-sensing and card-in. Also disclosed are systems and methods for pairing of user mobile devices with gaming devices for providing for transfer of funds. In one embodiment of the disclosed system and method for wireless-enabled player-sensing and card-in system, the system components include a Bluetooth-enabled gaming machine, a Bluetooth-enabled smartphone, a casino Bluetooth application, and a gaming machine Bluetooth receiver. In other embodiments, a wireless protocol other than Bluetooth is utilized.

A Bluetooth-enabled gaming machine is a gaming machine with Bluetooth capability. The system hardware (e.g., iVIEW or MC350) is equipped with a Bluetooth module for player card-in and card-out activities. The Bluetooth-enabled smartphone may be either the patron's smartphone or an employee's smartphone with Bluetooth hardware. The smartphone includes the hardware and processing power to run a custom smartphone application. The casino Bluetooth application is the custom smartphone application that controls the Bluetooth hardware of the smartphone to actively carry out card-in/card-out and Mobile Fund Transfer functionality.

Typically, a Bluetooth receiver has antennas that sense other Bluetooth devices in 360 degree spherical radius. However, since a player needs to be in front of a gaming machine and in close proximity to the gaming machine, the receiver antenna of the gaming machine Bluetooth receiver for the wireless-enabled player-sensing and card-in system is specially configured to receive signals from smartphones in a restricted lobe (i.e., in front of the gaming machine).

In one embodiment of the wireless-enabled player-sensing and card-in system, a Bluetooth profile used in the card-in/card-out application is SPP (Serial Port Profile). SPP may be used instead of a serial communication interface (e.g., RS-232 or a UART) with Bluetooth. SPP sends bursts of data between two devices. Using SPP, each connected device sends and receives data just as if there were RX (reception) and TX (transmission) lines connected between the devices. In this embodiment of the wireless-enabled player-sensing and card-in system, the smartphone and gaming machine, for example, may converse with each other during mobile payment or card-out.

Typically, the range of Bluetooth wireless communication is from 10 m to 100 m. However, for the card-in/card-out application in one embodiment of the wireless-enabled player-sensing and card-in system, the Bluetooth range is reduced (using the antenna and application) to a very small area around a gaming machine or table game. This enables the Bluetooth on gaming machine to interact with only a smartphone that is very close (and in front) to the gaming machine.

Referring now to FIG. 1, in one such embodiment of the wireless-enabled player-sensing and card-in system, the area around gaming machine is divided into three areas; a card-in area, a player sensing area, and an out of range area. The card-in area is the area in front of the gaming machine. This is the area where the received signal strength (RSS) is the strongest. In the Bluetooth receiver of the gaming machine, the RSSI threshold value is configured such that the signals from smartphones brought into the card-in area are higher than the configured RSSI threshold. Only under this condition, may a “card-in” event take place. The Player sensing area is the area outside the card-in area of the gaming machine. The RSSI threshold value in the gaming machine is configured such that the signals from smartphones brought into the player sensing area are less than the configured RSSI threshold. During this condition, the gaming machine can sense that a player is in front of the gaming machine, but a “card-in” event cannot take place. The Out of range area is an area Outside Player Sensing area where Bluetooth signal strength is very weak, and devices are unlikely to be detected. Accordingly, devices present in this area cannot be sensed by a gaming machine.

In some embodiments of the wireless-enabled player-sensing and card-in system, the gaming machine contains a Bluetooth module integrated with a custom made antenna that restricts player card-in/card-out over a small area without interfering with the nearby gaming machine Bluetooth devices. In one such embodiment, the Bluetooth module on gaming machine is always in discoverable mode making itself visible to all the devices present around it. To make use of the system, the player's smartphone also has Bluetooth capabilities. In one such embodiment, the player registers his mobile with the casino. This action maps his smartphone's “Bluetooth Device Address (BDDR)” to his “Player ID” in database. The player installs the smartphone application of the system for Bluetooth card-in/card-out and Bluetooth Mobile Fund Transfer. The database stores the BDDR and Player ID mapping. The BDDR can be stored in encrypted format to enhance security. Since Bluetooth devices can communicate with each other by one device being in Master Mode and the other device being in Slave Mode, there are two ways to carry out card-in/card-out of a player at casino when using the wireless-enabled player-sensing and card-in system.

In one embodiment of the wireless-enabled player-sensing and card-in system, card-in and card-out of the player and the gaming machine may be achieved using Bluetooth automatically. As described above, Bluetooth devices may communicate with each other by designating one device in the Master Mode and the other device in Slave Mode. Accordingly, there are two different ways in which the player's smartphone and the gaming machine may interact (e.g., card-in/card-out, funds transfer, and the like) as Bluetooth device. In the first example, the gaming machine is the master device and smartphone is the slave device. In the second example, the smartphone is the master device and gaming machine is the slave device.

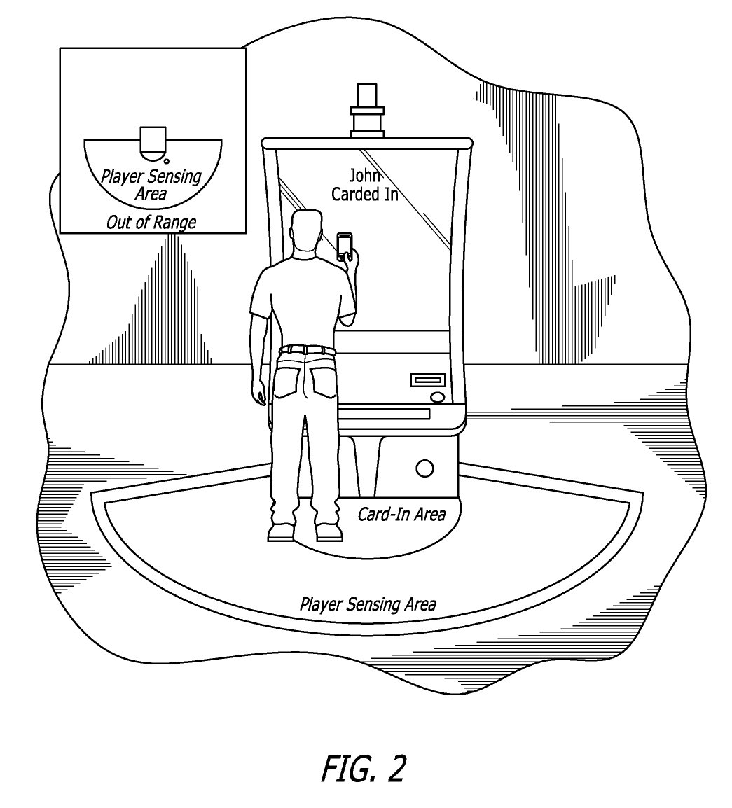

Referring now to FIGS. 2, 3, and 11, an embodiment of the wireless-enabled player-sensing and card-in system is shown with the gaming machine as master device and smartphone as the slave device. In one embodiment, a player in a casino starts out standing far away from the Bluetooth-enabled gaming machine. At this point, the Bluetooth-enabled gaming machine does not sense the player's smartphone, since it is to be outside the player sensing area. As the player walks towards Bluetooth-enabled gaming machine, the player takes out a registered smartphone on which a casino Bluetooth application is installed. The Bluetooth application is in running state already or the patron starts the application. As player steps even closer to the Bluetooth-enabled gaming machine, the Bluetooth-enabled gaming machine detects the presence of player's smartphone by receiving its broadcasted BDDR address and calculating the player's mobile Bluetooth received signal strength (RSS). If the RSS is strong enough for a card-in event, the Bluetooth-enabled gaming machine waits for a steady Bluetooth signal from the smartphone to ensure intended card-in and remove false triggering if the player is just walking past the Bluetooth-enabled gaming machine.

Continuing, in one embodiment of the wireless-enabled player-sensing and card-in system, the Bluetooth-enabled gaming machine presents the player name on the iVIEW display screen (or other player tracking screen) with a “CARD IN” button next to his name. If the player presses the CARD IN button, the Bluetooth-enabled gaming machine sends a pairing request to the smartphone. The player responds by keying his player PIN on his smartphone or the Bluetooth-enabled gaming machine. In the situation where the player is entering his pin on smartphone (to ensure that “card-in” event is happening at Bluetooth-enabled gaming machine at which player is looking), a secondary verification may be performed to ensure that player card-in happens at the same Bluetooth-enabled gaming machine. This may be achieved by entering a two digit number on Bluetooth-enabled gaming machine that is displayed on mobile (or QR code scanning) Alternatively, the player may also respond by entering his player pin on the Bluetooth-enabled gaming machine.

Referring to FIG. 4, in one embodiment of the wireless-enabled player-sensing and card-in system, after the card-in process is complete, the player begins playing the game. During game play, the Bluetooth-enabled gaming machine continuously polls the smartphone for its presence to ensure that the player is close by to the gaming machine. If the smartphone cannot be sensed, it could mean that the player has moved out of range of the Bluetooth-enabled gaming machine, without carding out. This would mandate an automatic card-out. However, to ensure no card-out happens due to false trigger, the following logic is implemented. During card-in, the RSSI threshold value is set high enough such that only intentional “card-in” events can happen. However, once the “card-in” event happens, the player may put the smartphone in his back pocket and continue to play. Accordingly, the RSSI threshold may be lowered during game play so that the player does not have to be unnecessarily close to the Bluetooth-enabled gaming machine (or keep their smartphone unnecessarily close to the Bluetooth-enabled gaming machine).

When the RSSI threshold is lowered during game play, the following steps are performed to monitor the RSSI threshold during game play. The RSS value of the signal received from the smartphone is checked. This RSS value is compared with the lowered threshold set after card-in. If the RSSI value is less than the threshold, the patron is considered to be carded-out. Accordingly, the Bluetooth-enabled gaming machine performed a card-out for the player. Next, the BDDR address received during the continuous polling is compared with the value of the BDDR obtained while carding-in. This comparison is performed to ensure that the same player is playing at the Bluetooth-enabled gaming machine.

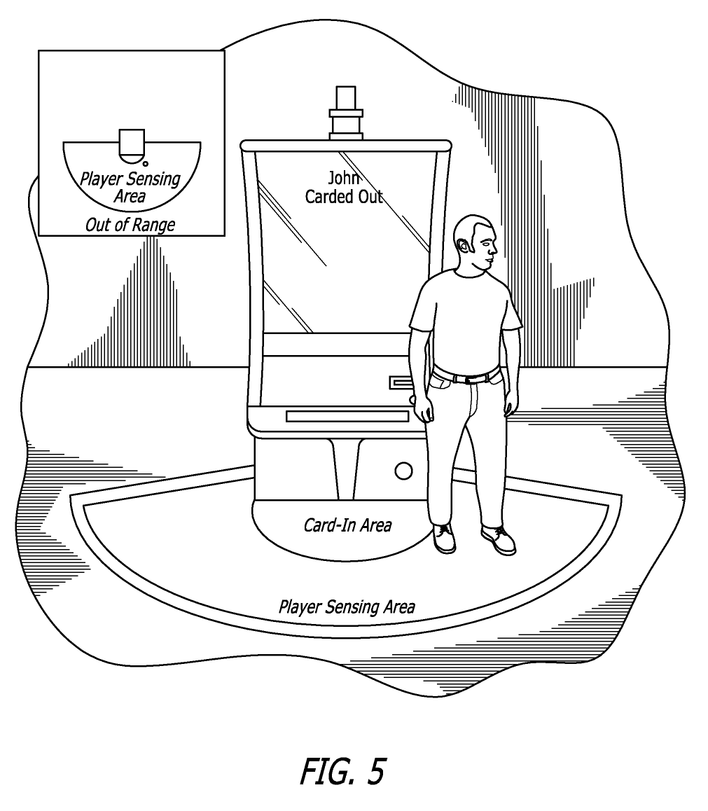

Referring to FIG. 5, in one aspect of the wireless-enabled player-sensing and card-in system, the player is now going through the card-out process. In one embodiment of the system, to card-out automatically, a player simply just walks away from the Bluetooth-enabled gaming machine. As the player walks away from the Bluetooth-enabled gaming machine, the RSS value of the smartphone at the Bluetooth-enabled gaming machine drops below a threshold value, thus making the player automatically card-out. As explained above, the card-out threshold is greater than card-in threshold to allow “restrictive card-in but lenient card-out.”

In another aspect of the wireless-enabled player-sensing and card-in system, the system handles other card-in requests during game play. In this scenario, when a player is already playing at the Bluetooth-enabled gaming machine, the Bluetooth-enabled gaming machine ignores the card-in possibility (including physical card like mag-strip/smart card) of any other player. However, in this scenario the player can perform a funds transfer with its smartphone if the player is carded-in using a physical card.

In still another aspect of the wireless-enabled player-sensing and card-in system, the system may detect multiple players at the Bluetooth-enabled gaming machine. In this scenario, several players are close to the Bluetooth-enabled gaming machine and have their smartphones within the card-in area. To ensure that the intended card-in happens, the Bluetooth-enabled gaming machine displays a list of players identified on its screen. For example, the Bluetooth-enabled gaming machine may display a message such as: “Multiple mobile devices detected. Are you Name 1? Name 2? Name 3?” In this example, Name 1/Name 2/Name 3 are obtained by comparing the BDDR mappings against the names from the database. If a player selects his name, the card in happens for this player.

In still another aspect of the wireless-enabled player-sensing and card-in system, the system enables a player to manually card-out of a Bluetooth-enabled gaming machine. In this regard, the Bluetooth-enabled gaming machine and the corresponding casino Bluetooth application provide players with an option to manually card-out. Specifically, the player can do so by pressing a button on either the Bluetooth-enabled gaming machine or the smartphone application. Player may use this feature to be assured that he has carded-out.

In yet another aspect of the wireless-enabled player-sensing and card-in system, if a player forgets to card-out, the system can inform a casino employee. Even though the system is configured to ensure that a player card-out occurs when the player walks away from the Bluetooth-enabled gaming machine, the player can also ask an employee to perform the card-out event after the player has walked away from Bluetooth-enabled gaming machine. In this scenario, the employee may perform a manual card-out by using the information on mapping between the smartphones and the Bluetooth-enabled gaming machines.

Referring now to FIGS. 2, 3, and 12, an embodiment of the wireless-enabled player-sensing and card-in system is shown with the smartphone as the master device and gaming machine as the slave device. In one embodiment, the Bluetooth module in the smartphone acts as the master device and the Bluetooth-enabled gaming machine acts as the slave device. Accordingly, there is a role reversal between the Bluetooth-enabled gaming machine and the smartphone.

In one such embodiment, the player card-in process begins when the player walks up to the Bluetooth-enabled gaming machine he wants to play. The player turns on the casino Bluetooth application of the wireless-enabled player-sensing and card-in system. The Casino Bluetooth application in the smartphone scans the nearby Bluetooth-enabled gaming machine. The Bluetooth-enabled gaming machine responds with its BDDR. The application waits for a steady and constant signal for certain amount of time from the Bluetooth-enabled gaming machine. Next, the smartphone sends a pairing request. The Bluetooth-enabled gaming machine then asks the Player to enter the secret Player PIN, upon receiving a pairing request from the smartphone. The player then enters the secret PIN, and upon successful authentication, is “carded-in” at the Bluetooth-enabled gaming machine.

Referring again to FIG. 4, in one embodiment of the wireless-enabled player-sensing and card-in system, after the card-in process is complete, the player begins playing the game. During game play, the casino Bluetooth application on the smartphone continuously polls the Bluetooth-enabled gaming machine for its presence to ensure that the player is close by to the Bluetooth-enabled gaming machine. If the Bluetooth-enabled gaming machine cannot be sensed, it could mean that the player has moved out of range of the Bluetooth-enabled gaming machine, without carding out. This would mandate an automatic card-out. However, to ensure that a card-out does not occur due to a false trigger, the following logic is used.

During card-in, the RSSI threshold value is set high enough such that only intentional “card-in” events can happen. However, once the “card-in” event happens, the player may put the phone in his back pocket and continue to play. Accordingly, the RSSI threshold may be lowered during game play so that the player does not have to be unnecessarily close to the Bluetooth-enabled gaming machine (or keep their smartphone unnecessarily close to the Bluetooth-enabled gaming machine).

When the RSSI threshold is lowered during game play, following steps are performed to monitor the RSSI threshold during game play. The Casino Bluetooth application on the smartphone keeps checking the RSS value of the signal received from the Bluetooth-enabled gaming machine. This RSS value is compared with the lowered threshold set after card-in. If the RSSI value is less than the threshold, the patron is considered to be carded-out. Accordingly, the smartphone performed a card-out for the player. Next, the BDDR address received during the continuous polling is compared with the value of the BDDR obtained while carding-in. This comparison is performed to ensure that the same player is playing at the Bluetooth-enabled gaming machine.

Referring to FIG. 5, in one aspect of the wireless-enabled player-sensing and card-in system, the player is now going through the card-out process. In one embodiment of the system, to card-out automatically, a player simply just walks away from the Bluetooth-enabled gaming machine. As the player walks away from the Bluetooth-enabled gaming machine, the RSS value of the Bluetooth-enabled gaming machine drops below a threshold value, thus making the player automatically card-out. As explained above, the card-out threshold is greater than card-in threshold to allow “restrictive card-in but lenient card-out.”

In another aspect of the wireless-enabled player-sensing and card-in system, the system handles other card-in requests during game play. In this scenario, when a player is already playing at the Bluetooth-enabled gaming machine, the Bluetooth-enabled gaming machine ignores the card-in possibility (including physical card like mag-strip/smart card) of any other player. However, in this scenario the player can perform a funds transfer with its smartphone if the player is carded-in using a physical card.

In still another aspect of the wireless-enabled player-sensing and card-in system, the system may detect multiple players at the Bluetooth-enabled gaming machine. In this scenario, several players are close to the Bluetooth-enabled gaming machine and have their smartphones within the card-in area. To ensure that the intended card-in happens, the Bluetooth-enabled gaming machine displays a list of players identified on its screen. For example, the Bluetooth-enabled gaming machine may display a message such as: “Multiple mobile devices detected. Are you Name 1? Name 2? Name 3?” In this example, Name 1/Name 2/Name 3 are obtained by comparing the BDDR mappings against the names from the database. If a player selects his name, the card in happens for this player.

In yet another aspect of the wireless-enabled player-sensing and card-in system, the system enables a player to manually card-out of a Bluetooth-enabled gaming machine. In this regard, the Bluetooth-enabled gaming machine and the corresponding casino Bluetooth application provide players with an option to manually card-out. Specifically, the player can do so by pressing a button on either the Bluetooth-enabled gaming machine or the smartphone application. Player may use this feature to be assured that he has carded-out.

In another aspect of the wireless-enabled player-sensing and card-in system, if a player forgets to card-out, the system can inform a casino employee. Even though the system is configured to ensure that a player card-out occurs when the player walks away from the Bluetooth-enabled gaming machine, the player can also ask an employee to perform the card-out event after the player has walked away from Bluetooth-enabled gaming machine. In this scenario, the employee may perform a manual card-out by using the information on mapping between the smartphones and the Bluetooth-enabled gaming machines.

Referring now to FIGS. 2, 3, and 13, an embodiment of the wireless-enabled player-sensing and card-in system is shown where the smartphone and gaming machine are in a role interchangeable mode. In one embodiment, the Bluetooth module in the smartphone and the Bluetooth-enabled gaming machine interchange their master/slave roles during the player card-in process. In one such embodiment, the process may begin with a player in a casino standing too far away from the Bluetooth-enabled gaming machine. As such, the Bluetooth-enabled gaming machine may not sense the player's smartphone if it is outside the player sensing area. The player walks up to the Bluetooth-enabled gaming machine he wants to play. The player turns on the casino Bluetooth application of the wireless-enabled player-sensing and card-in system. As player gets close to the Bluetooth-enabled gaming machine, the Bluetooth-enabled gaming machine detects the presence of player's smartphone by receiving its broadcasted BDDR address. The Bluetooth-enabled gaming machine calculates the received signal strength (RSS) of the player's smartphone. If the RSS is strong enough for card-in, the Bluetooth-enabled gaming machine waits for a steady Bluetooth signal from the smartphone to ensure that the card-in is intended, thereby preventing a false triggering if the player is just walking past the Bluetooth-enabled gaming machine.

Continuing, in one embodiment of the wireless-enabled player-sensing and card-in system, the Bluetooth-enabled gaming machine displays the player's name on the iVIEW display screen (or other player tracking display screen) with a “CARD IN” button next to his name. If the player presses the “CARD IN” button, the Bluetooth-enabled gaming machine sends a pairing request to the smartphone. The player responds by entering his player PIN on his smartphone or the Bluetooth-enabled gaming machine. In scenario where the player is entering his pin on smartphone (to ensure that card-in is happening at Bluetooth-enabled gaming machine at which player is looking), a secondary verification may be performed to ensure the player card-in happens at the same Bluetooth-enabled gaming machine. This may be achieved by entering a two digit number on Bluetooth-enabled gaming machine that is displayed on the smartphone (or by scanning of a QR code). The player may also respond by entering his player PIN on the Bluetooth-enabled gaming machine.

Referring once again to FIG. 4, in one embodiment of the wireless-enabled player-sensing and card-in system, after the card-in process is complete, the player begins playing the game. During game play, the Bluetooth-enabled gaming machine continuously polls the smartphone for its presence to ensure that the player is close by to the gaming machine. If the smartphone cannot be sensed, it could mean that the player has moved out of range of the Bluetooth-enabled gaming machine, without carding out. This would mandate an automatic card-out. However, to ensure no card-out happens due to false trigger, the following logic is implemented. During card-in, the RSSI threshold value is set high enough such that only intentional “card-in” events can happen. However, once the “card-in” event happens, the player may put the smartphone in his back pocket and continue to play. Accordingly, the RSSI threshold may be lowered during game play so that the player does not have to be unnecessarily close to the Bluetooth-enabled gaming machine (or keep their smartphone unnecessarily close to the Bluetooth-enabled gaming machine).

When the RSSI threshold is lowered during game play, following steps are performed to monitor the RSSI threshold during game play. The RSS value of the signal received from the smartphone is checked. This RSS value compared with the lowered threshold set after card-in. If the RSSI value is less than the threshold, the patron is considered to be carded-out. Accordingly, the Bluetooth-enabled gaming machine performed a card-out for the player. Next, the BDDR address received during the continuous polling is compared with the value of the BDDR obtained while carding-in. This comparison is performed to ensure that the same player is playing at the Bluetooth-enabled gaming machine.

Referring once again to FIG. 5, in one aspect of the wireless-enabled player-sensing and card-in system, the player is now going through the card-out process. In one embodiment of the system, to card-out automatically, a player simply just walks away from the Bluetooth-enabled gaming machine. As the player walks away from the Bluetooth-enabled gaming machine, the RSS value of the smartphone at the Bluetooth-enabled gaming machine drops below a threshold value, thus making the player automatically card-out. As explained above, the card-out threshold is greater than card-in threshold to allow “restrictive card-in but lenient card-out.”

Referring now to another embodiment of the wireless-enabled player-sensing and card-in system, the system enables mobile based fund transfer using Bluetooth. Specifically, using the wireless-enabled player-sensing and card-in system, a player (once carded-in) can transfer funds to the Bluetooth-enabled gaming machine from their mobile wallet (account) using the casino Bluetooth application. For this process to occur, the player's mobile wallet account must contain a sufficient balance. Typically, the player is required to pass an authenticate procedure before the fund transfer can occur.

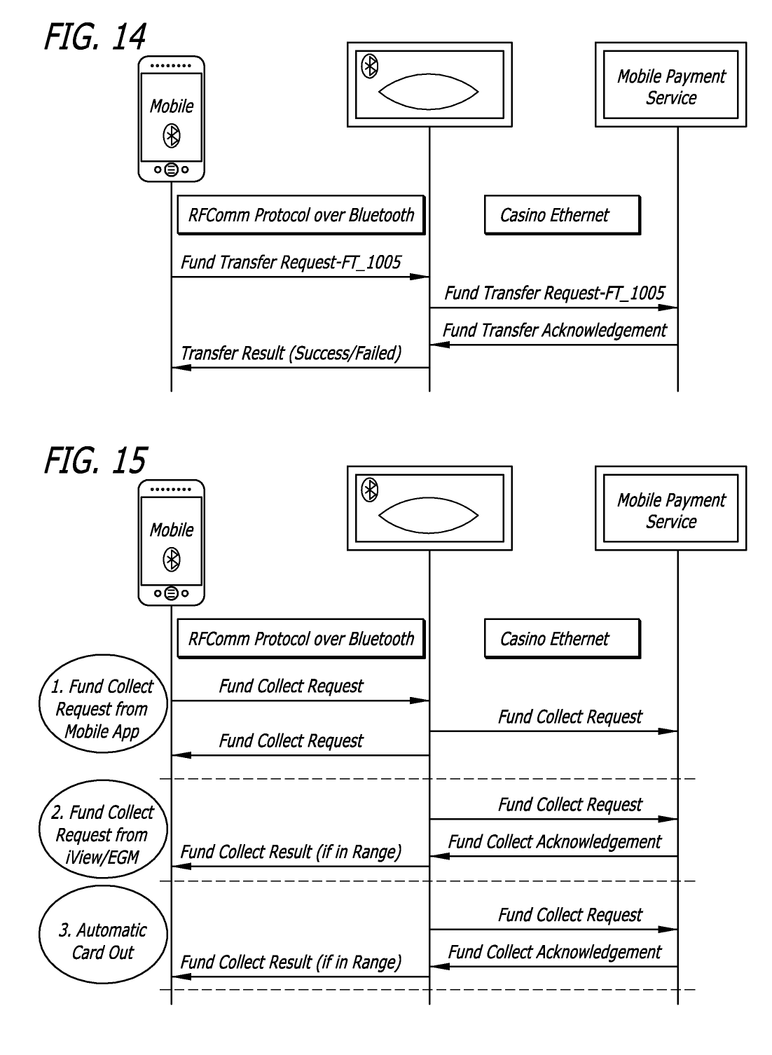

As shown in FIG. 14, in one aspect of the wireless-enabled player-sensing and card-in system, funds are transferred from a smartphone to a Bluetooth-enabled gaming machine. In one such scenario where a player wants to transfer funds from a smartphone to a Bluetooth-enabled gaming machine, the player has to first pair the smartphone with the Bluetooth-enabled gaming machine before securely transferring funds to Bluetooth-enabled gaming machine.

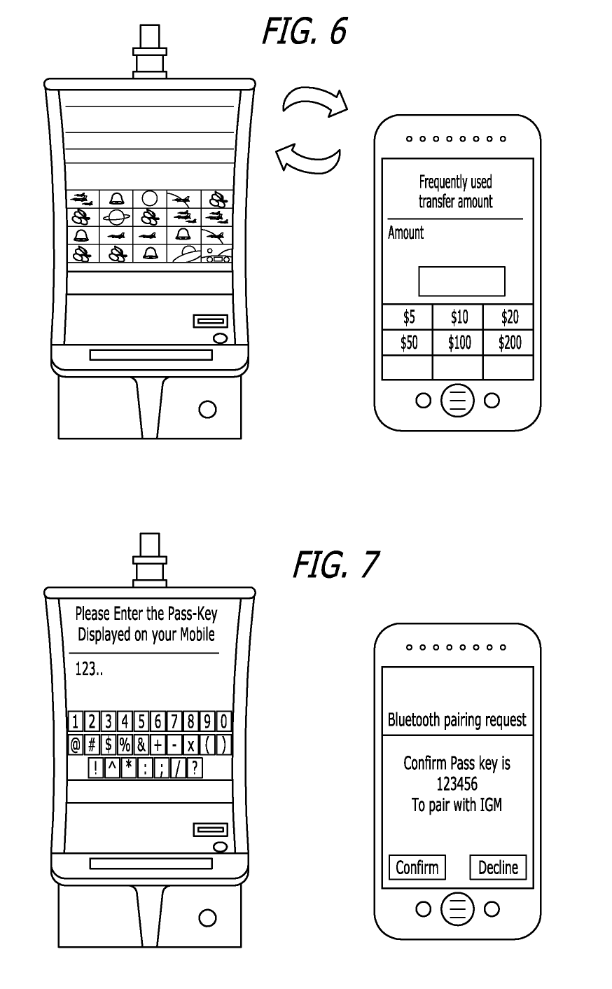

In one embodiment, funds are transferred from the smartphone to Bluetooth-enabled gaming machine as follows: (1) the player opens the casino Bluetooth application and selects the amount to be transferred (See FIG. 6); (2) once the fund transfer is initiated, the application asks the player to authenticate himself with a Player PIN; (3) funds are transferred to Bluetooth-enabled gaming machine through the casino Bluetooth application in the smartphone, and a success or error message is displayed on smartphone and Bluetooth-enabled gaming machine (See FIG. 7); (4) the iView (or other device on the Bluetooth-enabled gaming machine) sends the player-entered amount to the casino mobile payment service; (5) the mobile payment service authorizes the payment and sends the acknowledgement to iView; (6) iView uses AFT mode of transfer to transfer the fund to the game; (7) the player is enabled to play with the added credits on the game; (8) the iView communicates to the smartphone regarding status of fund transfer; and (9) the mobile application displays the fund transfer status and the current fund on the screen.

Fund transfer from the smartphone to the Bluetooth-enabled gaming machine can happen multiple times while the patron is carded in to the Bluetooth-enabled gaming machine. For every such funds transfer, the above process is executed. Accordingly, the patron has to enter his player PIN for every transfer of fund due to security.

As shown in FIG. 15, in one aspect of the wireless-enabled player-sensing and card-in system, funds are transferred from a Bluetooth-enabled gaming machine to a smartphone. In such a scenario, the player wants to transfer funds from Bluetooth-enabled gaming machine to their mobile wallet. This can occur in the following ways: (1) when the player presses the “collect” button on either the Bluetooth-enabled gaming machine or the smartphone, (2) when the player presses “card-out” button on the smartphone, and (3) when the player moves away from the Bluetooth-enabled gaming machine for a configured period, the system does an automatic card-out. This is to ensure no other player can play with the credits left on the game.

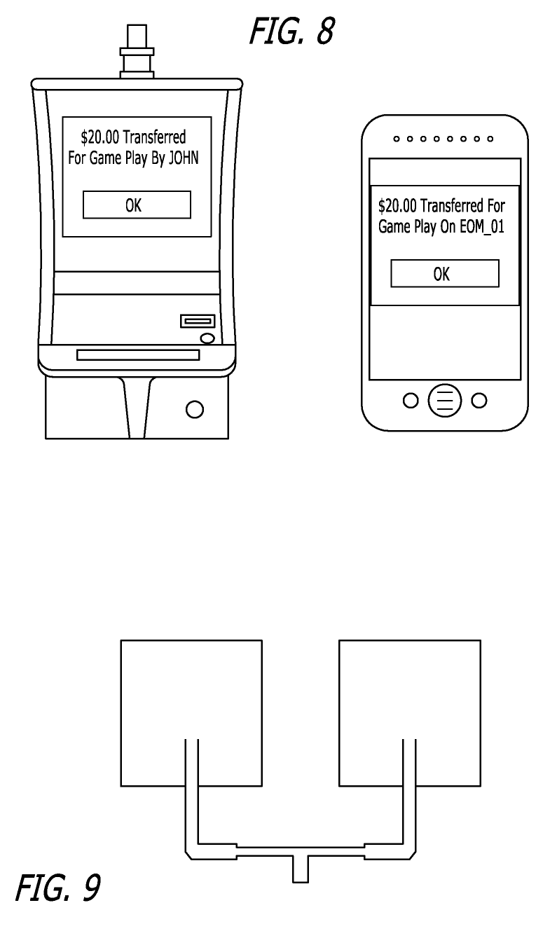

In one embodiment, funds are transferred from the Bluetooth-enabled gaming machine to the smartphone as follows: (1) the player cards-out using any of the approaches described above; (2) the iView client sends a “collect” message to the mobile payment service; (3) the mobile payment service authorizes this request and sends an acknowledgement to iView; (4) the iVIEW attempts to send the acknowledgement to mobile phone over Bluetooth (if the patron is closer to the Bluetooth-enabled gaming machine, the mobile application receives the information and updates its screen accordingly); and (5) if the patron has moved away from the Bluetooth-enabled gaming machine, iView cannot communicate over Bluetooth. In this scenario, the patron may receive the transfer information to mobile wallet when he is carded in at another Bluetooth-enabled gaming machine/Kiosk by using the history option in the mobile application. As shown in FIG. 8, a success/error message is displayed on the smartphone and the Bluetooth-enabled gaming machine.

Referring now to another aspect of the wireless-enabled player-sensing and card-in system, the system enables low level Bluetooth communication between a Bluetooth-enabled gaming machine (or iVIEW) and a smartphone. According to one such embodiment, communication may occur between the Bluetooth-enabled gaming machine (or iVIEW) and the smartphone during various phase of interaction between the smartphone and the Bluetooth-enabled gaming machine. Once the player is carded-in, the Bluetooth-enabled gaming machine and the smartphone ensure that the player is at the gaming machine. This is achieved through a periodic “handshake” or a keep-alive signal between them. If the periodic keep alive is not received for a configured duration, the patron is carded-out.

Following are the Bluetooth level handshake steps for communication between the smartphone and the Bluetooth-enabled gaming machine. When the player is in the card-in area, the smartphone or iVIEW senses the other partner device. This is based on which device is the master device. The master device sends the connection request to the slave device. The slave device accepts the connection. For further communication, RFComm mode of communication is opened. Now the master device sends the card-in message to the slave device. If the card-in is authorized, the card-in acknowledgement is sent back to the master device. After the player is carded-in, the Bluetooth-enabled gaming machine and the smartphone are paired for two way communication. The devices communicate using RFComm protocol which is essentially an emulated serial port communication.

Continuing, when the player is carded-in, the Bluetooth-enabled gaming machine sends a “keep alive” signal when the RSSI value of communication between the Bluetooth-enabled gaming machine and the smartphone drops close to a lower threshold. This ensures that the Bluetooth-enabled gaming machine is able to recognize that the patron is close by the Bluetooth-enabled gaming machine. If the smartphone does not respond to the “keep alive” signal, the Bluetooth-enabled gaming machine presumes that the player has stepped away. In this scenario, the Bluetooth-enabled gaming machine cards-out the player and transfers the remaining credits on the game to the player's mobile wallet. The “keep alive” message is communicated from iView to the smartphone and back over RFComm protocol.

With respect to funds transfer from the smartphone to Bluetooth-enabled gaming machine, the player-selected amount is sent to the Bluetooth-enabled gaming machine (or iVIEW) client using RFComm. The iView then transfers the funds to the game. Once the funds transfer to the game is complete, the iVIEW communicates over RFComm the status of the funds transfer.

With respect to funds transfer from the Bluetooth-enabled gaming machine to the smartphone, when the player cards out manually or automatically, the funds in the game are transferred to the mobile wallet. After the transfer, the iVIEW attempts to send the information using RFComm to the smartphone. If the smartphone is close by, the smartphone receives the information and updates the application screen accordingly.

Referring now to another aspect of the wireless-enabled player-sensing and card-in system, the casino Bluetooth application provides several player options, including card-in triggers, key-in methods, location based services, and geo-location assurance. By toggling the card-in triggers, a player may enable or disable automated card-in at the Bluetooth-enabled gaming machine. Disabling automated-card-in then requires the player to explicitly trigger the card-in process. Using key-in methods, a player may select where to key-in (i.e., Bluetooth-enabled gaming machine or smartphone) the player's secret PIN and other information during game play or card-in.

By using the option for location based services, a player can set a “Not in Casino” (i.e., disable card-in) option (password protected option) in the mobile application to ensure that the player is never carded-in until the player disables this option. The player's selection is communicated to server which assists the Bluetooth-enabled gaming machine to determine card-in events. Even in the case of a software malfunction, having such an option ensures that no card-in event can happen without players attention. Alternatively, a casino employee can be required to disable the “Not in Casino” option after player verification (i.e., player is in Casino premises) for added security. Additionally, by using a geo-location assurance option, a player's smartphone can provide geo-location data to the server, thereby ensuring that no card-in events are allowed if the player's geo-location is not inside casino.

Referring now to still another aspect of the wireless-enabled player-sensing and card-in system, the server in this system performs many notable operations. For example, the signal strength received by a Bluetooth-enabled gaming machine may vary depending upon the device. In some situations, multiple Bluetooth-enabled gaming machines can detect player “card-in” range. In such a situation, the central server can determine the nearest Bluetooth-enabled gaming machine to player. In this regard, when a Bluetooth-enabled gaming machine detects a player, it reports the RSSI and BDDR value to the server. The server, based on available data from multiple systems, determines the nearest Bluetooth-enabled gaming machine based on highest value of RSSI. The server also provides other functionality, as discussed above in the player options section.

In another aspect of the wireless-enabled player-sensing and card-in system, the smartphone may be used as a player card. Since each Bluetooth device has a unique 48 bit address, the MAC address of Bluetooth hardware in player's phone may act as a Player Card. The player is required to register their smartphone at the casino. The MAC address of player's smartphone is mapped to the player's physical card in casino database. Continuing, to ensure security, the MAC address of player can be encrypted using strong encryption algorithm such as SHA-512.

In this embodiment, the player's smartphone is now a mobile player card. As such, the player's mobile player card needs to be connected to the Bluetooth-enabled gaming machine. The Bluetooth in the Player's smartphone and the Bluetooth in the Bluetooth-enabled gaming machine can connect to each other using the Slave or Master Role. In the first scenario, the Bluetooth-enabled gaming machine is the Slave device and smartphone is the Master device. In the second scenario, the Bluetooth-enabled gaming machine is the Master device and smartphone is the Slave device.

Referring now to the first scenario (where the Bluetooth-enabled gaming machine is the Master device and the smartphone is the Slave device), the Bluetooth-enabled gaming machine is set in the inquiry mode. This mode can be set by providing a suitable HCI command to the BT module. Additionally, the smartphone's Bluetooth module is set in the discoverable mode.

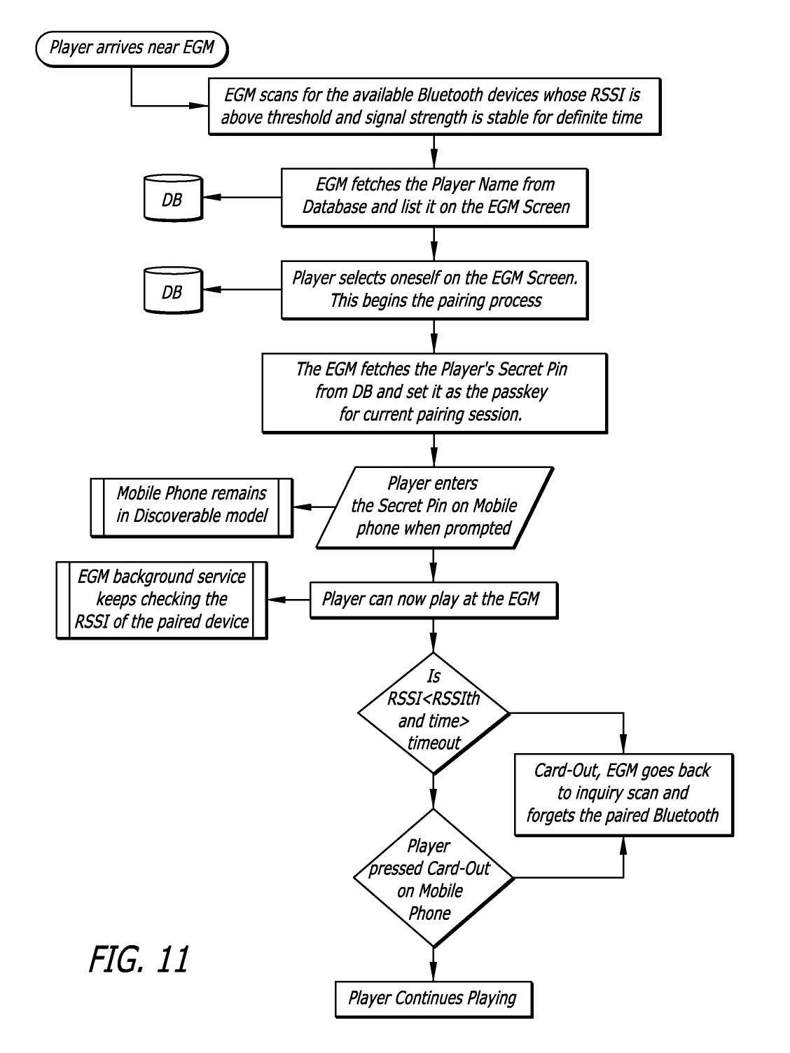

As shown in FIG. 11, when the Player arrives near the Bluetooth-enabled gaming machine, the Bluetooth application should be turned ON in the player's smartphone. The Bluetooth-enabled gaming machine scans for the slave device (e.g., smartphone) and its RSSI value. The player may be carded-in if the RSSI value is stable for a threshold time and is greater than the threshold RSSI value required for card-in to occur.

The positive features of using the first scenario are that (1) the smartphone App may be light-weight, since it has to just put the Bluetooth in discoverable mode, and (2) this configuration may be implemented on smartphone with Bluetooth without any customized application. The drawbacks of using the first scenario are that (1) the smartphone's Bluetooth being in discoverable mode could be a security issue, and (2) keeping the smartphone in virtual discoverable mode after card-in could be a hardware intensive process and may drain battery fast.

Referring now to the second scenario (where the Bluetooth-enabled gaming machine is the Slave device and the smartphone is the Master device), the Bluetooth-enabled gaming machine is set in the discoverable mode. Additionally, a customized Bluetooth Application (e.g., Ballytooth) for card-in is installed in the smartphone in this second scenario. Out of 48 bits of device address, 24 bits are used for the organization. Accordingly, in one embodiment, the first 24 bits of the address is set to be unique to manufacturer (e.g., an organizationally unique identifier). Further, COD (Class of Device) may be set for positioning and gaming purposes.

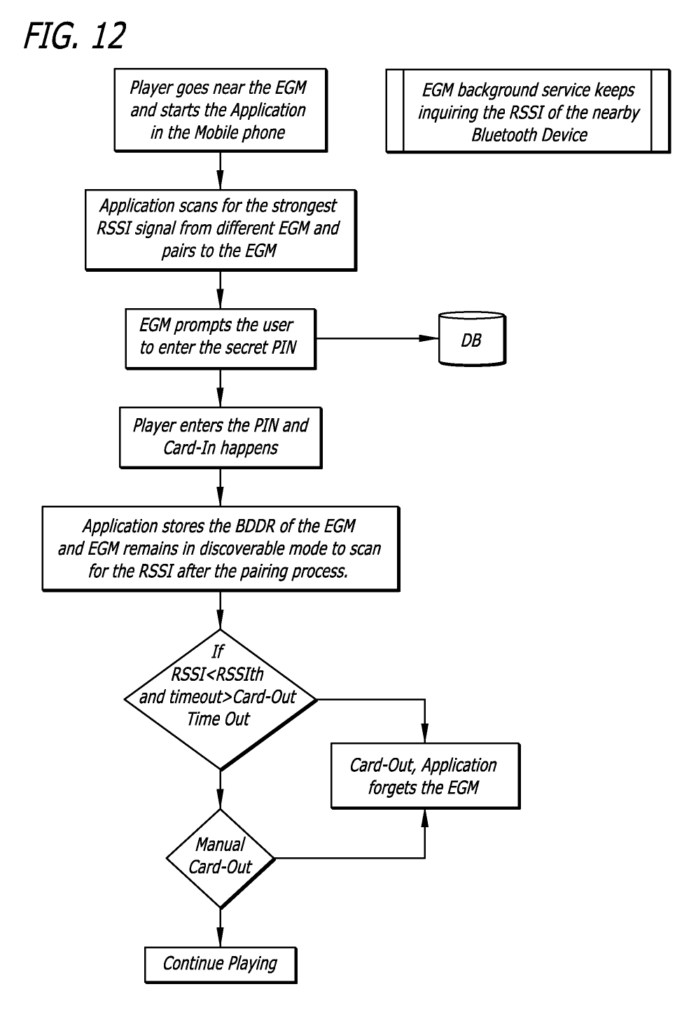

As shown in FIG. 12, when the player arrives near the Bluetooth-enabled gaming machine, the casino Bluetooth application should be turned ON in the player's smartphone. The smartphone scans for the slave device (e.g., Bluetooth-enabled gaming machine) and its RSSI value. The player may be carded-in if the RSSI value is stable for a threshold time and is greater than the threshold RSSI value required for card-in to occur. The positive features of using the second scenario are that (1) this configuration is more secure since the smartphone does not need to be in the discoverable mode all the time, and (2) this configuration is fully automated once the application is turned on. The main drawback of using the second scenario is that the smartphone application is more complex.

Referring now to another scenario (where the Bluetooth-enabled gaming machine and the smartphone are in Role Interchangeable Mode), the Bluetooth-enabled gaming machine is set in the discoverable mode. Additionally, a customized Bluetooth Application (e.g., Ballytooth) for card-in is installed in the smartphone. Out of 48 bits of device address, 24 bits are used for the organization. Accordingly, in one embodiment, the first 24 bits of the address is set to be unique to manufacturer (e.g., an organizationally unique identifier). Further, COD (Class of Device) may be set for positioning and gaming purposes.

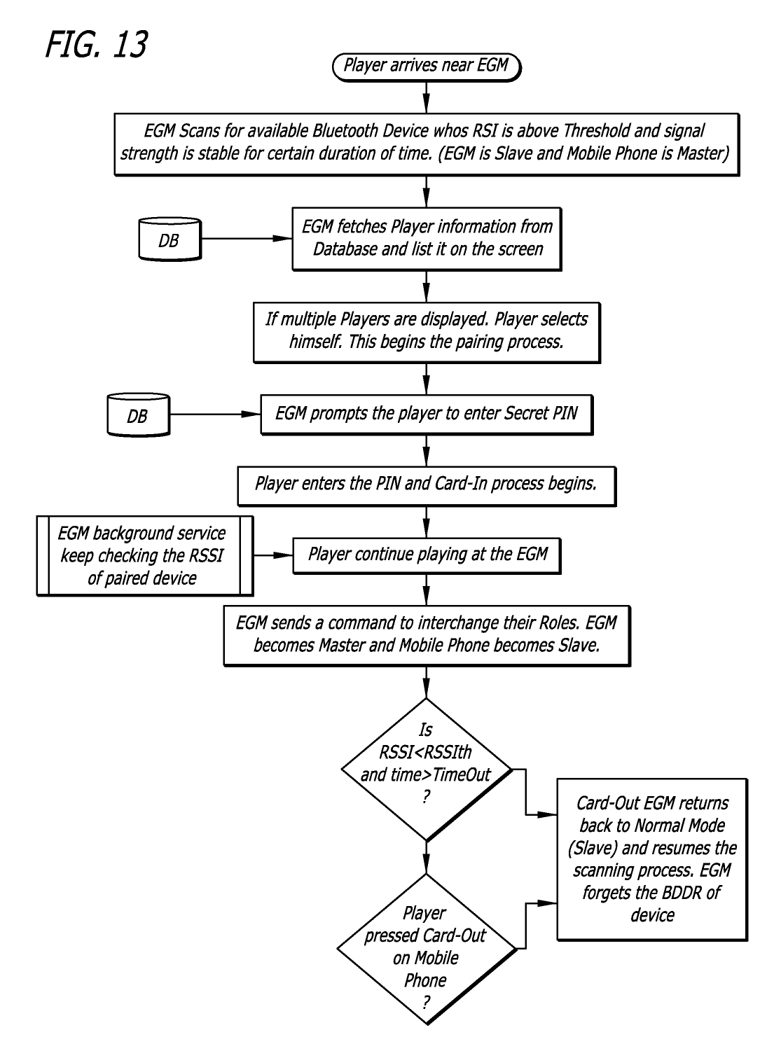

As shown in FIG. 13, when the player arrives near the Bluetooth-enabled gaming machine, the casino Bluetooth application should be turned ON in the player's smartphone. The smartphone scans for the slave device (e.g., Bluetooth-enabled gaming machine) and its RSSI value. The player may be carded-in if the RSSI value is stable for a threshold time and is greater than the threshold RSSI value required for card-in to occur. The Bluetooth-enabled gaming machine application then interchanges the Role for smartphone and itself. The positive features of using the second scenario are that (1) this configuration is more secure since the smartphone does not need to be in the discoverable mode all the time, (2) this configuration is fully automated once the application is turned on, and (3) the mobile application is light-weight (e.g., less complex).

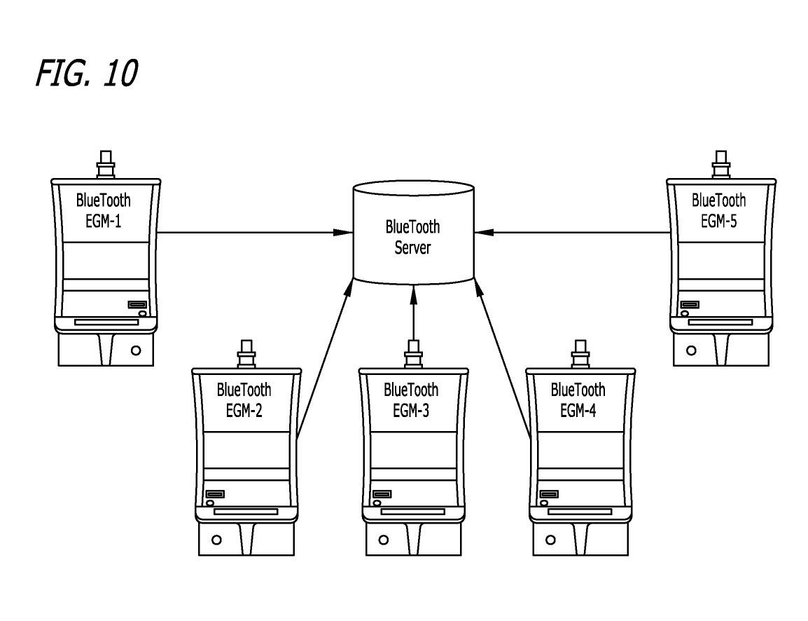

In one embodiment of the wireless-enabled player-sensing and card-in system, to resolve conflicts and ambiguity, the server tracks which Bluetooth-enabled gaming machine is occupied and by whom. Additionally, the server keeps records of each Bluetooth-enabled gaming machine on the casino floor. The server database contains a mapping table for Bluetooth-enabled gaming machine and Player (EGM_PLAYER), to keep the current status of Bluetooth-enabled gaming machine and Player. Also in case of a conflict where more than one Bluetooth-enabled gaming machine detects an RSSI value greater than the threshold, the server takes over and compares both the RSSI values and card-in at the Bluetooth-enabled gaming machines. The server then determines where RSSI value is greater. Referring now to FIG. 10, this mapping table ensures that same player is not carded-in at more than one Bluetooth-enabled gaming machine. The mapping table also ensures that only a single player can occupy a Bluetooth-enabled gaming machine.

In one embodiment, the wireless-enabled player-sensing and card-in system includes several hardware components, including the Bluetooth module and a custom, shorter range, directional antenna. The Bluetooth Module may be any Bluetooth module that supports SPP (Serial Port Profile) such as HC-05, HM-10, or HM-11. Referring now to the custom directional antenna, the range of standard Bluetooth antenna is about 10 m. These standard Bluetooth antennas are omni-directional antennas. To support the card-in/card-out application of the wireless-enabled player-sensing and card-in system, custom antennas are used with a shorter range and directional properties.

In some embodiments, the wireless-enabled player-sensing and card-in system includes a general antenna design with the following properties: (1) limit range to approximately one foot, (2) limit direction to 30 degree (from center on either side). As shown in FIG. 9, in one embodiment, the technical antenna design has the following properties: (1) Di-electric substrate: Epoxy FH4 (PCB Material), (2) Di-electric constant: 4.5, and (3) Substrate Height: 1.6 mm.

Referring now to the casino Bluetooth application of the wireless-enabled player-sensing and card-in system, the configuration of the casino Bluetooth application varies depending on whether smartphone is in master mode or slave mode. When the smartphone is in the slave mode, the application turns on the Bluetooth functionality and keeps it in discoverable mode throughout the session. When the smartphone is in the master mode, the application turns on the Bluetooth functionality, scan the Bluetooth-enabled gaming machine based on RSSI Threshold level, pairs with a Bluetooth-enabled gaming machine that is in close proximity, and cards-out if the received RSSI value is less than the RSSI-card out threshold.

Referring now to the gaming machine application of the wireless-enabled player-sensing and card-in system, the gaming machine application is configured to run on a GMU platform, such as iVIEW or MC350. The configuration of the gaming machine application varies depending on whether Bluetooth-enabled gaming machine is in master mode or slave mode. When the Bluetooth-enabled gaming machine is in the master mode, the gaming machine application makes itself discoverable, obtains the BDDR data from the smartphone, obtains the player ID that matches the BDDR data received from the smartphone, displays a welcome message on the screen with player name, and sends a pairing request to the smartphone used by the player. The Bluetooth-enabled gaming machine then fetches the player PIN from the database and sets it as the Passkey. Once the Bluetooth-enabled gaming machine and smartphone are paired, the Bluetooth-enabled gaming machine stops scanning other Bluetooth devices. Once the card-in process is completed, it keeps checking the RSSI value of paired device. Finally, the player is carded-out when the RSSI value from the smartphone is less than threshold value.

When the Bluetooth-enabled gaming machine is in the slave mode, the gaming machine application makes itself discoverable, modifies the first 24 bit of Bluetooth to the required casino property, asks player to enter the player PIN upon receiving a pairing request from the phone, matches the player PIN that came as a passkey with the database entry, and declines all other requests when paired. Once the card-in is completed, the Bluetooth-enabled gaming machine keeps checking the RSSI value of the paired device. The player is carded out when the RSSI value from the smartphone is less than threshold value.

Referring again to the gaming machine application of the wireless-enabled player-sensing and card-in system, in some embodiments the Bluetooth-enabled gaming machine and the smartphone are in role interchangeable mode. In this embodiment, the gaming machine application sets the Bluetooth in Slave Mode and discoverable. Next, the application modifies the first 24 bit of Bluetooth to the required casino property. Upon receiving a pairing request from the smartphone, the application asks the player to enter the player's PIN. Then the application matches the player PIN that came as a Passkey with the database entry. On a successful pairing, the application interchanges the role of smartphone and the Bluetooth-enabled gaming machine. The smartphone becomes the slave device and the Bluetooth-enabled gaming machine becomes master device. After this pairing, all other requests are declined. Once the card-in is completed, the Bluetooth-enabled gaming machine keeps checking the RSSI value of the paired device. The player is carded out when the RSSI value from the smartphone is less than threshold value.

Referring now to other aspects of the wireless-enabled player-sensing and card-in system, the card-in and card-out timeout is a notable feature for intentional card-in and card-out. card-in timeout is used to make sure that player is near the Bluetooth-enabled gaming machine for a certain duration before it can card-in automatically. This prevents a player from carding-in if he is walking near the Bluetooth-enabled gaming machine without an intention to play. Card-out timeout is used to make sure that player stepping out of the Bluetooth-enabled gaming machine area for a certain duration does not mean to activate a card-out. Therefore, the system is able to more accurately determine an intentional card-out.

In still another aspect of the wireless-enabled player-sensing and card-in system, the polling of the Bluetooth-enabled devices is controlled. After the card-in, the Bluetooth master device polls the slave device. This helps determine the RSSI value received at the slave device. If this value is greater than the card-out RSSI threshold, the connection between the slave device and master device is kept alive. When this value falls below the threshold, automatic card-out triggers in.

In yet another aspect of the wireless-enabled player-sensing and card-in system, the system works with non-carded players. In one such embodiment, an uncarded player downloads the mobile application and registers himself through the mobile application. A PlayerID is generated from a group of IDs allocated for this purpose. Mapping between player ID and the patron smartphone BDDR is kept in the player database. When the uncarded patron reaches the card-in area of the gaming machine, a welcome message may be displayed. Mobile payment may be extended in this manner for non-carded players as well. These players may deposit their cash at the cage against their mobile wallet and transfer it to the game for use.

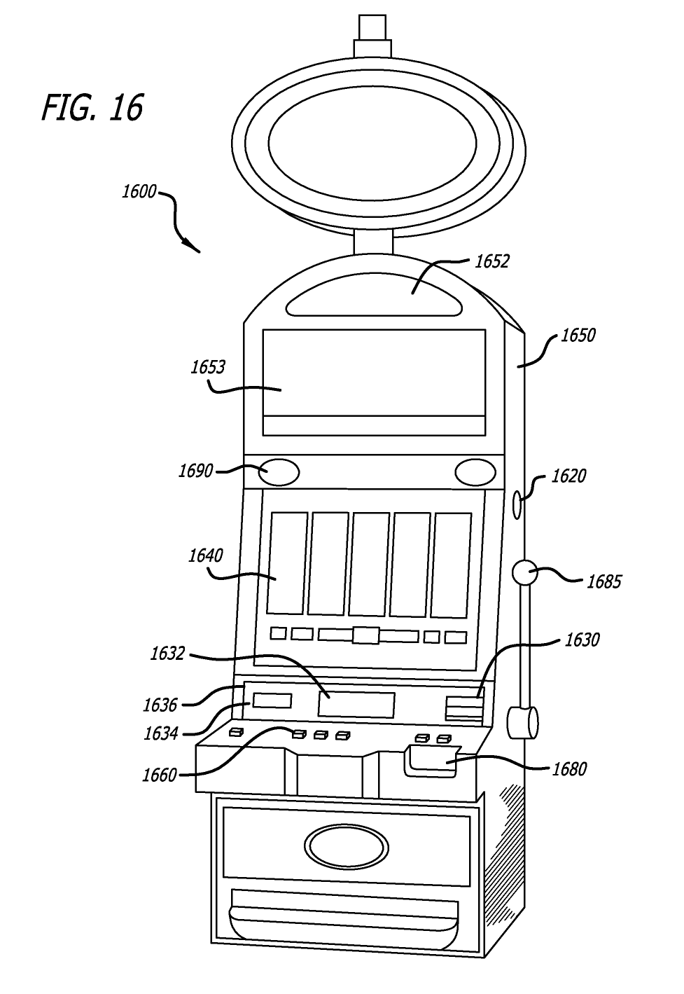

Referring to FIG. 16, gaming machine 1600 is capable of supporting various embodiments, including cabinet housing 1620, primary game display 1640 upon which a primary game and feature game may be displayed, top box 1650 which may display multiple progressives that may be won during play of the feature game, player-activated buttons 1660, player tracking panel 1636, bill/voucher acceptor 1680 and one or more speakers 1690. Cabinet housing 1620 may be a self-standing unit that is generally rectangular in shape and may be manufactured with reinforced steel or other rigid materials which are resistant to tampering and vandalism. Cabinet housing 1620 may alternatively be a handheld device including the gaming functionality as discussed herein and including various of the described components herein. For example, a handheld device may be a cell phone, personal data assistant, or laptop or tablet computer, each of which may include a display, a processor, and memory sufficient to support either stand-alone capability such as gaming machine 1600 or thin client capability such as that incorporating some of the capability of a remote server.

In one or more embodiments, cabinet housing 1620 houses a processor, circuitry, and software (not shown) for receiving signals from the player-activated buttons 1660, operating the games, and transmitting signals to the respective displays and speakers. Any shaped cabinet may be implemented with any embodiment of gaming machine 1600 so long as it provides access to a player for playing a game. For example, cabinet 1620 may comprise a slant-top, bar-top, or table-top style cabinet, including a Bally Cinevision™ or CineReels™ cabinet. The operation of gaming machine 1600 is described more fully below.

The plurality of player-activated buttons 1660 may be used for various functions such as, but not limited to, selecting a wager denomination, selecting a game to be played, selecting a wager amount per game, initiating a game, or cashing out money from gaming machine 1600. Buttons 1660 may be operable as input mechanisms and may include mechanical buttons, electromechanical buttons or touch screen buttons. Optionally, a handle 1685 may be rotated by a player to initiate a game.

In one or more embodiments, buttons 1660 may be replaced with various other input mechanisms known in the art such as, but not limited to, a touch screen system, touch pad, trackball, mouse, switches, toggle switches, or other input means used to accept player input such as a Bally iDeck™. One other example input means is a universal button module as disclosed in U.S. Patent Publication No. 20060247047, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 1620 may optionally include top box 1650 which contains “top glass” 1652 comprising advertising or payout information related to the game or games available on gaming machine 1600. Player tracking panel 1636 includes player tracking card reader 1634 and player tracking display 1632. Voucher printer 1630 may be integrated into player tracking panel 1636 or installed elsewhere in cabinet housing 1620 or top box 1650.

Game display 1640 may present a game of chance wherein a player receives one or more outcomes from a set of potential outcomes. For example, one such game of chance is a video slot machine game. In other aspects of the invention, gaming machine 1600 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include game displays such as mechanical reels, wheels, or dice as required to present the game to the player. In video/mechanical or pure video embodiments, game display 1640 is, typically, a CRT or a flat-panel display in the form of, but not limited to, liquid crystal, plasma, electroluminescent, vacuum fluorescent, field emission, or any other type of panel display known or developed in the art. Game display 1640 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 1640 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference in its entirety for all purposes.

Game display 1640 may also present information such as, but not limited to, player information, advertisements and casino promotions, graphic displays, news and sports updates, or even offer an alternate game. This information may be generated through a host computer networked with gaming machine 1600 on its own initiative or it may be obtained by request of the player using either one or more of the plurality of player-activated buttons 1660; the game display itself, if game display 1640 comprises a touch screen or similar technology; buttons (not shown) mounted about game display 1640 which may permit selections such as those found on an ATM machine, where legends on the screen are associated with respective selecting buttons; or any player input device that offers the required functionality.

Cabinet housing 1620 incorporates a single game display 1640. However, in alternate embodiments, cabinet housing 1620 or top box 1650 may house one or more additional displays 1653 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

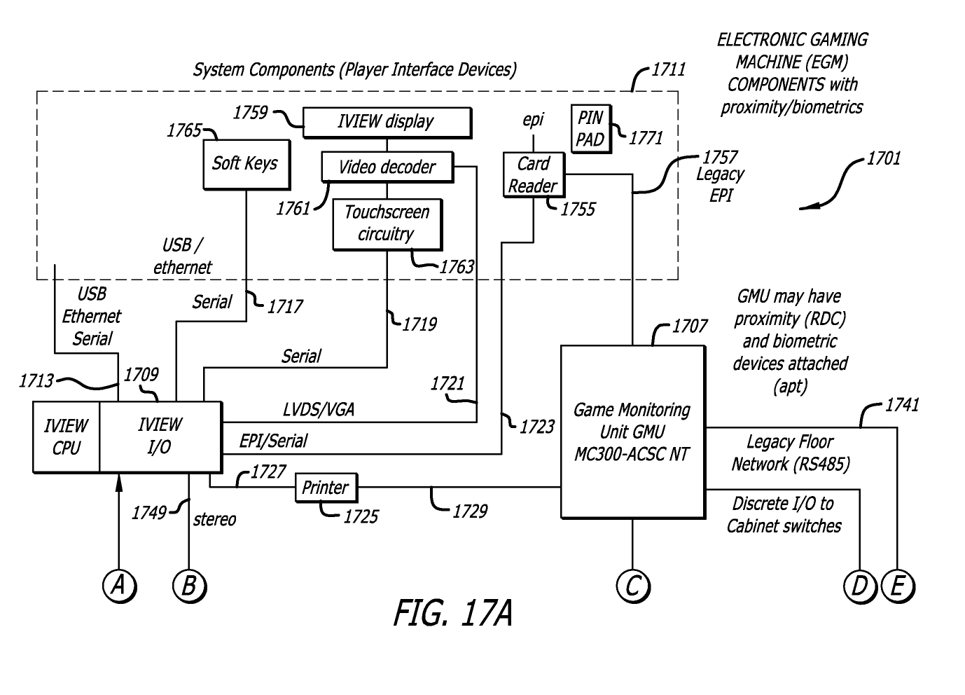

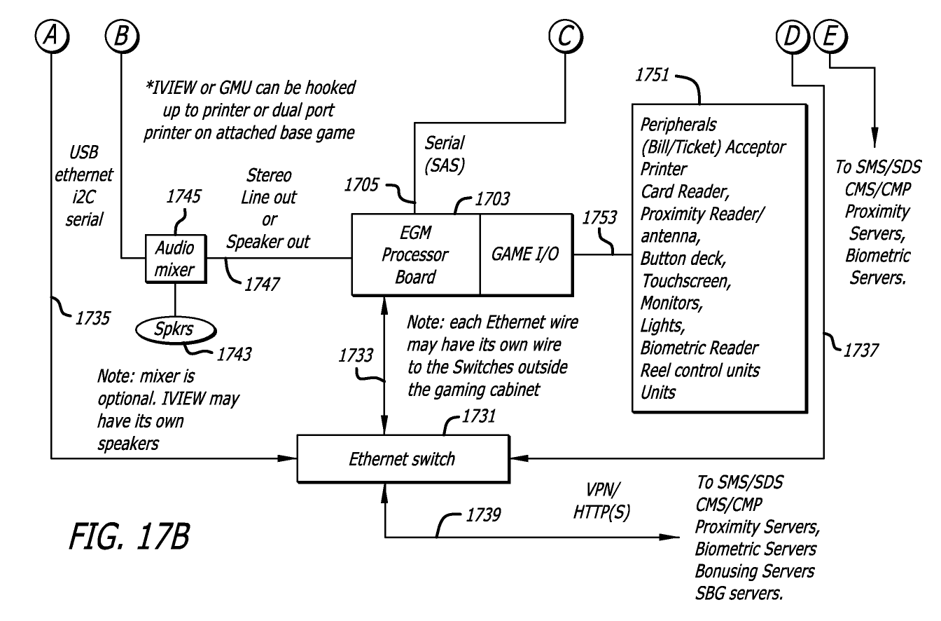

Referring to FIGS. 17A and 17B, electronic gaming machine 1701 is shown in accordance with one or more embodiments. Electronic gaming machine 1701 includes base game integrated circuit board 1703 (EGM Processor Board) connected through serial bus line 1705 to game monitoring unit (GMU) 1707 (such as a Bally MC300 or ACSC NT), and player interface integrated circuit board (PIB) 1709 connected to player interface devices 1711 over bus lines 1713, 1715, 1717, 1719, 1721, 1723. Printer 1725 is connected to PIB 1709 and GMU 1707 over bus lines 1727, 1729. Base game integrated circuit board 1703, PIB 1709, and GMU 1707 connect to Ethernet switch 1731 over bus lines 1733, 1735, 1737. Ethernet switch 1731 connects to a slot management system (SMS) and a casino management system (CMS) network over bus line 1739. GMU 1707 also may connect to the SMS and CMS network over bus line 1741. Speakers 1743 connect through audio mixer 1745 and bus lines 1747, 1749 to base game integrated circuit board 1703 and PIB 1709. The proximity and biometric devices and circuitry may be installed by upgrading a commercially available PIB 1709, such as a Bally iView™ unit. Coding executed on base game integrated circuit board 1703, PIB 1709, and/or GMU 1707 may be upgraded to integrate a game in accordance with one or more embodiments of the invention described herein, as is more fully described below.

Peripherals 1751 connect through I/O board 1753 to base game integrated circuit board 1703. For example, a bill/ticket acceptor is typically connected to a game input-output board 1753 which is, in turn, connected to a conventional central processing unit (“CPU”) base game integrated circuit board 1703, such as an Intel Pentium microprocessor mounted on a gaming motherboard. I/O board 1753 may be connected to base game integrated circuit board 1703 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. Base game integrated circuit board 1703 executes a game program that causes base game integrated circuit board 1703 to play a game. In one embodiment, the game program provides a slot machine game having adjustable multi-part indicia. The various components and included devices may be installed with conventionally and/or commercially available components, devices, and circuitry into a conventional and/or commercially available gaming machine cabinet, examples of which are described above.

When a player has inserted a form of currency such as, for example and without limitation, paper currency, coins or tokens, cashless tickets or vouchers, electronic funds transfers or the like into the currency acceptor, a signal is sent by way of I/O board 1753 to base game integrated circuit board 1703 which, in turn, assigns an appropriate number of credits for play in accordance with the game program. The player may further control the operation of the gaming machine by way of other peripherals 1751, for example, to select the amount to wager via electromechanical or touch screen buttons. The game starts in response to the player operating a start mechanism such as a handle or touch screen icon. The game program includes a random number generator to provide a display of randomly selected indicia on one or more displays. In some embodiments, the random generator may be physically separate from gaming machine 1700; for example, it may be part of a central determination host system which provides random game outcomes to the game program. Thereafter, the player may or may not interact with the game through electromechanical or touch screen buttons to change the displayed indicia. Finally, base game integrated circuit board 1703 under control of the game program and OS compares the final display of indicia to a pay table. The set of possible game outcomes may include a subset of outcomes related to the triggering of a feature game. In the event the displayed outcome is a member of this subset, base game integrated circuit board 1703, under control of the game program and by way of I/O Board 1753, may cause feature game play to be presented on a feature display.

Predetermined payout amounts for certain outcomes, including feature game outcomes, are stored as part of the game program. Such payout amounts are, in response to instructions from base game integrated circuit board 1703, provided to the player in the form of coins, credits or currency via I/O board 1753 and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 1707 includes an integrated circuit board and GMU processor and memory including coding for network communications, such as the G2S (game-to-system) protocol from the Gaming Standards Association, Las Vegas, Nev., used for system communications over the network. As shown, GMU 1707 may connect to card reader 1755 through bus 1757 and may thereby obtain player card information and transmit the information over the network through bus 1741. Gaming activity information may be transferred by the base game integrated circuit board 1703 to GMU 1707 where the information may be translated into a network protocol, such as S2S, for transmission to a server, such as a player tracking server, where information about a player's playing activity may be stored in a designated server database.

PIB 1709 includes an integrated circuit board, PID processor, and memory which includes an operating system, such as Windows CE, a player interface program which may be executable by the PID processor together with various input/output (I/O) drivers for respective devices which connect to PIB 1709, such as player interface devices 1711, and which may further include various games or game components playable on PIB 1709 or playable on a connected network server and PIB 1709 is operable as the player interface. PIB 1709 connects to card reader 1755 through bus 1723, display 1759 through video decoder 1761 and bus 1721, such as an LVDS or VGA bus.

As part of its programming, the PID processor executes coding to drive display 1759 and provide messages and information to a player. Touch screen circuitry interactively connects display 1759 and video decoder 1761 to PIB 1709, such that a player may input information and cause the information to be transmitted to PIB 1709 either on the player's initiative or responsive to a query by PIB 1709. Additionally soft keys 1765 connect through bus 1717 to PIB 1709 and operate together with display 1759 to provide information or queries to a player and receive responses or queries from the player. PIB 1709, in turn, communicates over the CMS/SMS network through Ethernet switch 1731 and busses 1735, 1739 and with respective servers, such as a player tracking server.

Player interface devices 1711 are linked into the virtual private network of the system components in gaming machine 1701. The system components include the iView processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to install on the system components.

The system components include the iView™ processing board and game monitoring unit (GMU) processing board. The GMU and iView™ can be combined into one like the commercially available Bally GTM iView device. This device may have a video mixing technology to mix the EGM processor's video signals with the iView display onto the top box monitor or any monitor on the gaming device.

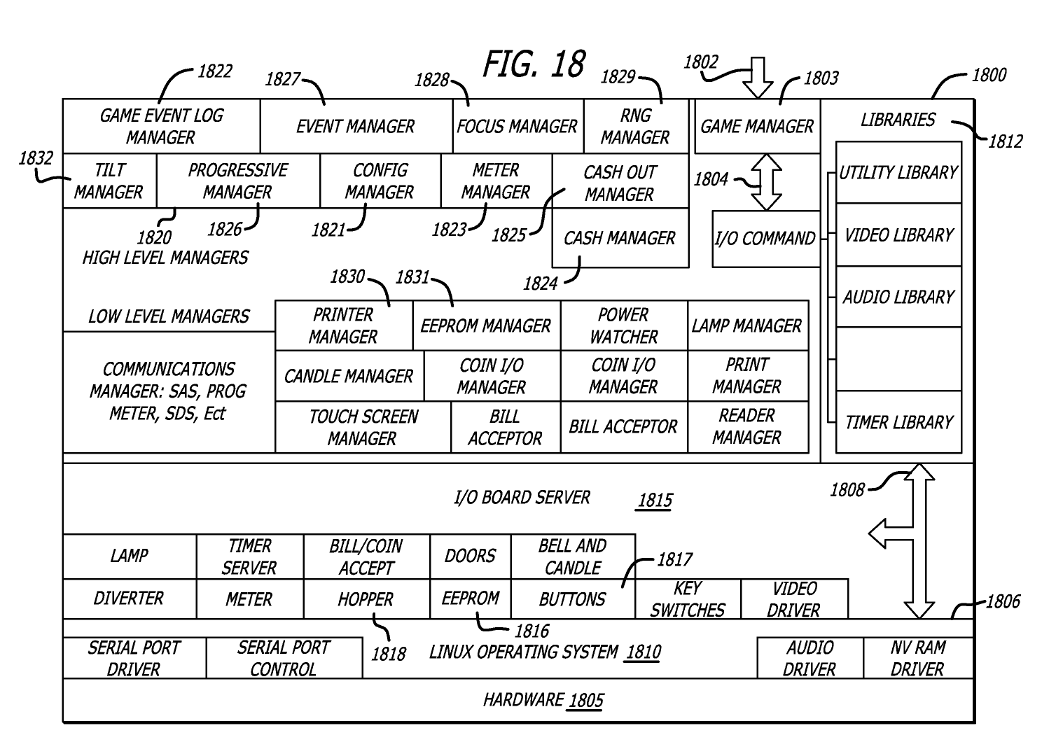

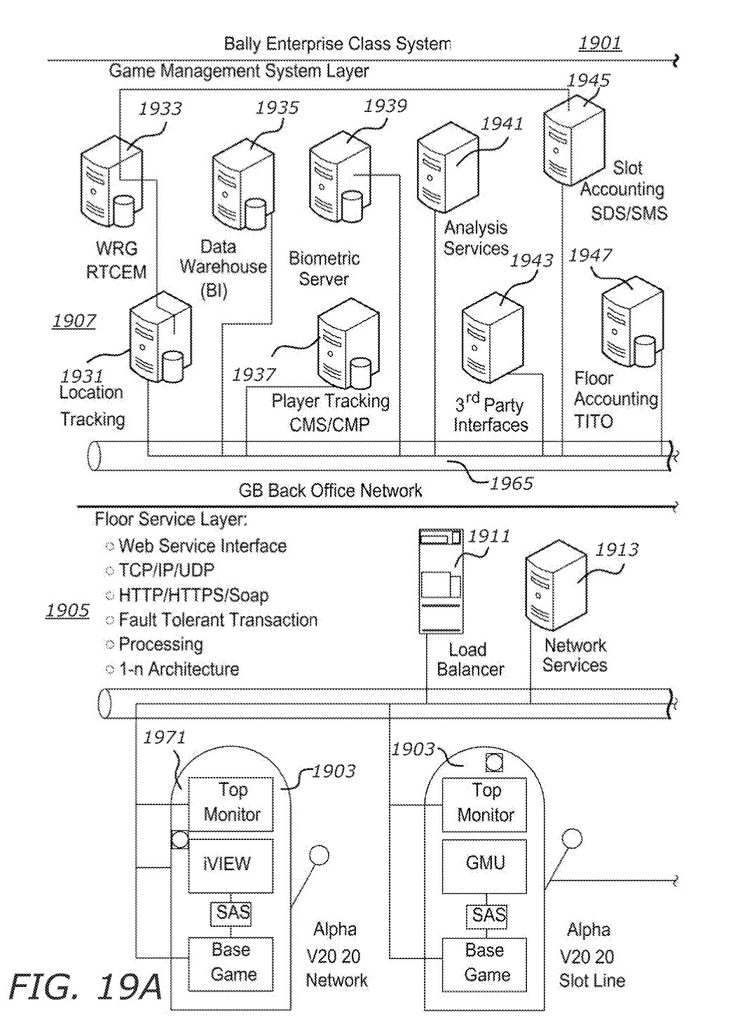

In accordance with one or more embodiments, FIG. 18 is a functional block diagram of a gaming kernel 1800 of a game program under control of base game integrated circuit board 1803. The game program uses gaming kernel 1800 by calling into application programming interface (API) 1802, which is part of game manager 1803. The components of game kernel 1800 as shown in FIG. 18 are only illustrative, and should not be considered limiting. For example, the number of managers may be changed, additional managers may be added or some managers may be removed without deviating from the scope and spirit of the invention.

As shown in the example, there are three layers: a hardware layer 1805; an operating system layer 1810, such as, but not limited to, Linux; and a game kernel layer 1800 having game manager 1803 therein. In one or more embodiments, the use of a standard operating system 1810, such as UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 1800 executes at the user level of the operating system 1810, and itself contains a major component called the I/O Board Server 1815. To properly set the bounds of game application software (making integrity checking easier), all game applications interact with gaming kernel 1800 using a single API 1802 in game manager 1803. This enables game applications to make use of a well-defined, consistent interface, as well as making access points to gaming kernel 1800 controlled, where overall access is controlled using separate processes.

For example, game manager 1803 parses an incoming command stream and, when a command dealing with I/O comes in (arrow 1804), the command is sent to an applicable library routine 1812. Library routine 1812 decides what it needs from a device, and sends commands to I/O Board Server 1815 (see arrow 1808). A few specific drivers remain in operating system 1810's kernel, shown as those below line 1806. These are built-in, primitive, or privileged drivers that are (i) general (ii) kept to a minimum and (iii) are easier to leave than extract. In such cases, the low-level communication is handled within operating system 1810 and the contents passed to library routines 1812.

Thus, in a few cases library routines may interact with drivers inside operating system 1810, which is why arrow 1808 is shown as having three directions (between library utilities 1812 and I/O Board Server 1815, or between library utilities 1812 and certain drivers in operating system 1810). No matter which path is taken, the logic needed to work with each device is coded into modules in the user layer of the diagram. Operating system 1810 is kept as simple, stripped down, and common across as many hardware platforms as possible. The library utilities and user-level drivers change as dictated by the game cabinet or game machine in which it will run. Thus, each game cabinet or game machine may have a base game integrated circuit board 1803 connected to a unique, relatively dumb, and as inexpensive as possible I/O adapter board 1840, plus a gaming kernel 1800 which will have the game-machine-unique library routines and I/O Board Server 1815 components needed to enable game applications to interact with the gaming machine cabinet. Note that these differences are invisible to the game application software with the exception of certain functional differences (i.e., if a gaming cabinet has stereo sound, the game application will be able make use of API 1802 to use the capability over that of a cabinet having traditional monaural sound).

Game manager 1803 provides an interface into game kernel 1800, providing consistent, predictable, and backwards compatible calling methods, syntax, and capabilities by way of game application API 1802. This enables the game developer to be free of dealing directly with the hardware, including the freedom to not have to deal with low-level drivers as well as the freedom to not have to program lower level managers 1830, although lower level managers 1830 may be accessible through game manager 1803's interface 1802 if a programmer has the need. In addition to the freedom derived from not having to deal with the hardware level drivers and the freedom of having consistent, callable, object-oriented interfaces to software managers of those components (drivers), game manager 1803 provides access to a set of upper level managers 1820 also having the advantages of consistent callable, object-oriented interfaces, and further providing the types and kinds of base functionality required in casino-type games. Game manager 1803, providing all the advantages of its consistent and richly functional interface 1802 as supported by the rest of game kernel 1800, thus provides a game developer with a multitude of advantages.

Game manager 1803 may have several objects within itself, including an initialization object (not shown). The initialization object performs the initialization of the entire game machine, including other objects, after game manager 1803 has started its internal objects and servers in appropriate order. In order to carry out this function, the kernel's configuration manager 1821 is among the first objects to be started; configuration manager 1821 has data needed to initialize and correctly configure other objects or servers.

The upper level managers 1820 of game kernel 1800 may include game event log manager 1822 which provides, at the least, a logging or logger base class, enabling other logging objects to be derived from this base object. The logger object is a generic logger; that is, it is not aware of the contents of logged messages and events. The log manager's (1822) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 1823 manages the various meters embodied in the game kernel 1800. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 1823 receives its initialization data for the meters, during start-up, from configuration manager 1821. While running, the cash in (1824) and cash out (1825) managers call the meter manager's (1823) update functions to update the meters. Meter manager 1823 will, on occasion, create backup copies of the soft meters by storing the soft meters' readings in EEPROM. This is accomplished by calling and using EEPROM manager 1831.

In accordance with still other embodiments, progressive manager 1826 manages progressive games playable from the game machine. Event manager 1827 is generic, like log manager 1822, and is used to manage various gaming machine events. Focus manager 1828 correlates which process has control of various focus items. Tilt manager 1832 is an object that receives a list of errors (if any) from configuration manager 1821 at initialization, and during game play from processes, managers, drivers, etc. that may generate errors. Random number generator manager 1829 is provided to allow easy programming access to a random number generator (RNG), as a RNG is required in virtually all casino-style (gambling) games. RNG manager 1829 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 1825 has the responsibility of configuring and managing monetary output devices. During initialization, cash out manager 1825, using data from configuration manager 1821, sets the cash out devices correctly and selects any selectable cash out denominations. During play, a game application may post a cash out event through the event manager 1827 (the same way all events are handled), and using a call-back posted by cash out manager 1825, cash out manager 1825 is informed of the event. Cash out manager 1825 updates the credit object, updates its state in non-volatile memory, and sends an appropriate control message to the device manager that corresponds to the dispensing device. As the device dispenses dispensable media, there will typically be event messages being sent back and forth between the device and cash out manager 1825 until the dispensing finishes, after which cash out manager 1825, having updated the credit manager and any other game state (such as some associated with meter manager 1823) that needs to be updated for this set of actions, sends a cash out completion event to event manager 1827 and to the game application thereby. Cash in manager 1824 functions similarly to cash out manager 1825, only controlling, interfacing with, and taking care of actions associated with cashing in events, cash in devices, and associated meters and crediting.

In a further example, in accordance with one or more embodiments, I/O server 1815 may write data to the gaming machine EEPROM memory, which is located in the gaming machine cabinet and holds meter storage that must be kept even in the event of power failure. Game manager 1803 calls the I/O library functions to write data to the EEPROM. The I/O server 1815 receives the request and starts a low priority EEPROM thread 1816 within I/O server 1815 to write the data. This thread uses a sequence of 8 bit command and data writes to the EEPROM device to write the appropriate data in the proper location within the device. Any errors detected will be sent as IPC messages to game manager 1803. All of this processing is asynchronous.

In accordance with one embodiment, button module 1817 within I/O server 1815, polls (or is sent) the state of buttons every 2 ms. These inputs are debounced by keeping a history of input samples. Certain sequences of samples are required to detect a button was pressed, in which case the I/O server 1815 sends an inter-process communication event to game manager 1803 that a button was pressed or released. In some embodiments, the gaming machine may have intelligent distributed I/O which debounces the buttons, in which case button module 1817 may be able to communicate with the remote intelligent button processor to get the button events and simply relay them to game manager 1803 via IPC messages. In still another embodiment, the I/O library may be used for pay out requests from the game application. For example, hopper module 1818 must start the hopper motor, constantly monitor the coin sensing lines of the hopper, debounce them, and send an IPC message to the game manager 1803 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application No. 60/313,743, entitled “Form Fitting Upgrade Board Set For Existing Game Cabinets,” filed Aug. 20, 2001; the patent and provisional are both fully incorporated herein by explicit reference.

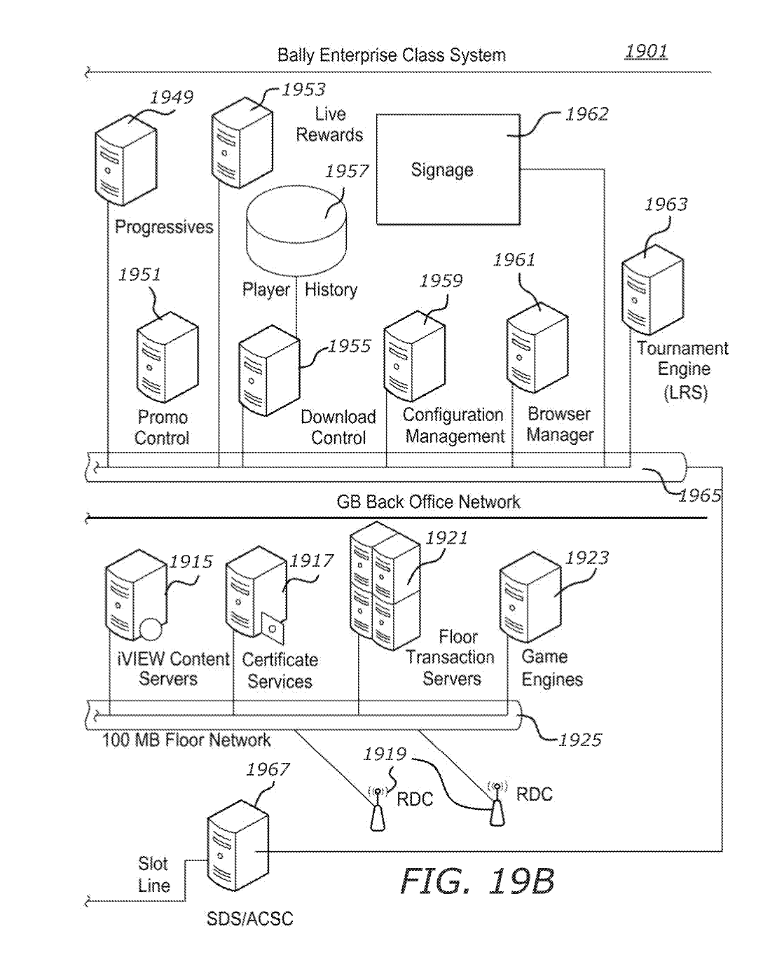

Referring to FIGS. 19A and 19B, enterprise gaming system 1901 is shown in accordance with one or more embodiments. Enterprise gaming system 1901 may include one casino or multiple locations and generally includes a network of gaming machines 1903, floor management system (SMS) 1905, and casino management system (CMS) 1907. SMS 1905 may include load balancer 1911, network services servers 1913, player interface (iView) content servers 1915, certificate services server 1917, floor radio dispatch receiver/transmitters (RDC) 1919, floor transaction servers 1921 and game engines 1923, each of which may connect over network bus 1925 to gaming machines 1903. CMS 1907 may include location tracking server 1931, WRG RTCEM server 1933, data warehouse server 1935, player tracking server 1937, biometric server 1939, analysis services server 1941, third party interface server 1943, slot accounting server 1945, floor accounting server 1947, progressives server 1949, promo control server 1951, feature game (such as Bally Live Rewards) server 1953, download control server 1955, player history database 1957, configuration management server 1959, browser manager 1991, tournament engine server 1963 connecting through bus 1965 to server host 1967 and gaming machines 1903. The various servers and gaming machines 1903 may connect to the network with various conventional network connections (such as, for example, USB, serial, parallel, RS485, Ethernet). Additional servers which may be incorporated with CMS 1907 include a responsible gaming limit server (not shown), advertisement server (not shown), and a control station server (not shown) where an operator or authorized personnel may select options and input new programming to adjust each of the respective servers and gaming machines 1903. SMS 1905 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming machines 1903 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 1907 and/or SMS 1905 servers and devices, firmware, media, operating systems, and configurations may be downloaded to the system components of respective gaming machines for upgrading or managing floor content and offerings in accordance with operator selections or automatically depending upon CMS 1907 and SMS 1905 master programming. The data and programming updates to gaming machines 1903 are authenticated using conventional techniques prior to install on the system components.

In various embodiments, any of the gaming machines 1903 may be a mechanical reel spinning slot machine or a video slot machine or a gaming machine offering one or more of the above described games including a group play game. Alternately, gaming machines 1903 may provide a game with a simulated musical instrument interface as a primary or base game or as one of a set of multiple primary games selected for play by a random number generator. A gaming system of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. Patent Publication No. 20080139305, entitled “Networked System and Method for Group Play Gaming,” filed on Nov. 9, 2007, which is hereby incorporated by reference in its entirety for all purposes.

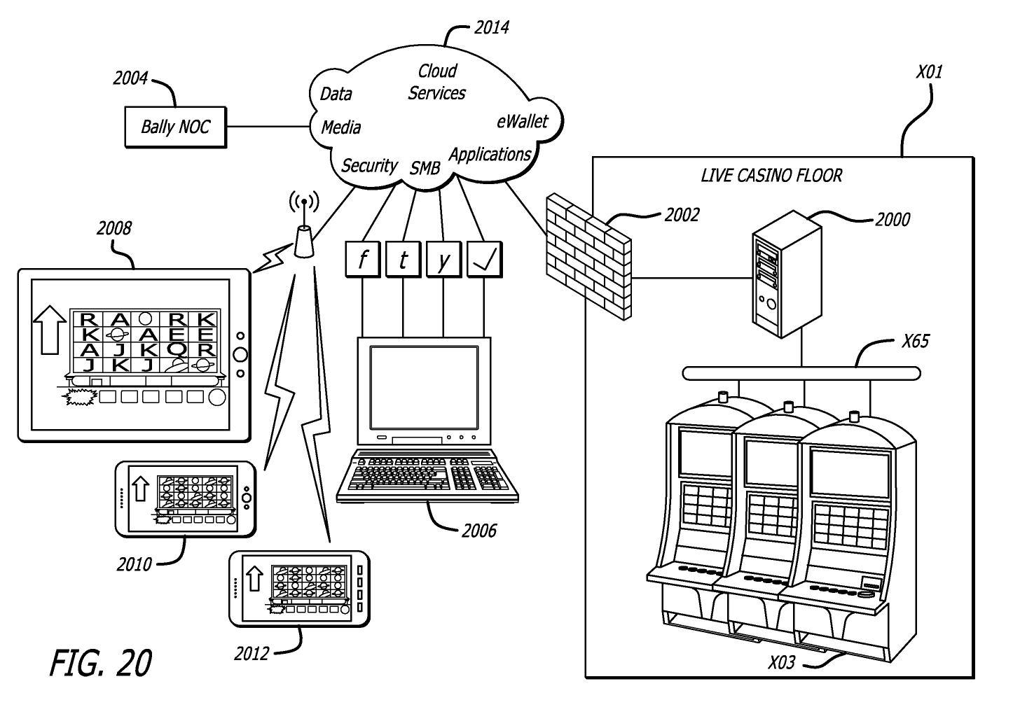

All or portions of the present invention may also be implemented or promoted by or through a system as suggested in FIG. 20. At 1901 is the gaming system of FIGS. 19A and 19B, which may be hosted at a casino property enterprise, across several casino enterprises or by a third party host. As described above, the gaming system 1901 has a network communication bus 1965 providing for communication between the gaming terminals 1903 and various servers. To provide the functionality illustrated in FIG. 20, a bonusing server 2000, such as a Bally Elite Bonusing Server is connected to the network communication bus 1965 (FIGS. 19A and 19B) for communication to the gaming system 1901, the gaming terminals 1903 and the various servers and other devices as described above. Through a secure network firewall 2002 the bonusing server 2000 is in communication with a cloud computing/storage service 2004 which may be hosted by the casino enterprise, a licensed third party or if permitted by gaming regulators an unlicensed provider. For example the cloud service 2004 may be as provided by Microsoft® Private Cloud Solutions offered by Microsoft Corp. of Redmond, Wash., USA.

The cloud service 2004 provides various applications which can be accessed and delivered to, for example, personal computers 2006, portable computing devices such as computer tablets 2008, personal digital assistants (PDAs) 2010 and cellular devices 2012 such as telephones and smart phones. As but an example, the cloud service 2004 may store and host an eWallet application, casino or player-centric applications such as downloadable or accessible applications including games, promotional material or applications directed to and/or affecting a casino customers interaction with a casino enterprise (such as accessing the players casino account, establishing casino credit or the like), providing bonuses to players through system wide bonusing (SMB) or specific bonusing or comps to players, or other applications. The cloud service 2004 includes security provided for secure communications with the cloud service 2004 between the player/users and the cloud service 2004 and between the cloud service 2004 and the gaming system 1901. Security applications may be through encryption, the use of personal identification numbers (PINS) or other devices and systems. As suggested in FIG. 20, the cloud service 2014 stores player/user data retrieved from players/users and from the gaming system 1901.

The players/users may access the cloud service 2004 and the applications and data provided thereby through the Internet or through broadband wireless cellular communication systems and any intervening sort range wireless communication such as WiFi. The players/users may access the applications and data through various social media offerings such as Facebook, Twitter, Yelp, MySpace, LinkedIn or the like.

As but an example, a player/user may have a player account with a casino enterprise Z. That account may include data such as the player's credit level, their rating and their available comps. The account may further track any certificates, and the present value thereof, the player may have won as a result of playing a game according to the present invention. At their smart phone 2012 the player/user sends a request to the cloud service 2004 (perhaps through a previously downloaded application) to request the status of their available comps such as how many comp points they have and what may be available through redemption of those points (e.g. lodging, cash back, meals or merchandise). The application for the request may present casino promotions, graphics or other advertising to the player/user. The application, to support such a request, would typically require the player/user to enter a PIN. The cloud service 2004 forwards the inquiry to the bonusing servicer 2000 which, in turn, confirms the PIN and retrieves the requested information from the data warehouse 1935 (FIGS. 19A and 19B) or player tracking CMS/CMP server 1937 (FIGS. 19A and 19B). Alternatively the data may be stored in the cloud service 2004 and routinely updated from the data warehouse 1935 or player tracking CMS/CMP server 1937. In this instance the request would be responded to from data residing with the cloud service 2004. The information is formatted by the cloud server 2004 application and delivered to the player/user. The delivery may be formatted based upon the player/user's device operating system (OS), display size or the like.

The cloud service 2000 may also host game applications to provide virtual instances of games for free, promotional, or where permitted, P2P (Pay to Play) supported gaming. Third party developers may also have access to placing applications with the cloud service 2004 through, for example a national operations center (Bally NOC 2014). A game software manufacturer such as Bally Gaming, Inc. may also provide game applications on its own or on behalf of the casino enterprise.

Other media such as advertising, notices (such as an upcoming tournament) may also be provided to the cloud service 2004. When a player/user accesses the cloud service 2004 certain media may be delivered to the player/user in a manner formatted for their application and device.

While the embodiment described relates to a Baccarat game it should be understood that the inventive concept could be applied to other games particularly those where inter-play player decisions are not required. For example, a slot machine, either electro-mechanical or video may operate one or more virtual games in the background and routinely report an outcome history to the player playing the primary, displayed, version of the game. The player may then compare the histories to the primary game and choose to instead play one of the one or more virtual background versions of the game. Each game version may operate from a differently seeded random number generator so the results (and histories may differ).

Still further the histories may be displayed at a window to either side, above or below the primary game version being wagered upon and played by the player or in a scrolling, ticker display again above or below or to either side of the primary game display. In such a fashion the player may view the histories and select a version of the game which the player may feel is “hotter” and is having better outcomes.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

While various embodiments have been described above, it should be understood that they have been presented by way of example only, and not limitation. Thus, the breadth and scope of a disclosed embodiment should not be limited by any of the above-described exemplary embodiments, but should be defined only in accordance with the following claims and their equivalents.

What is claimed:

1. A system configured to pair a mobile device with a terminal device, track interactions between the mobile device and the terminal device while paired, and un-pair the mobile device from the terminal device, wherein the terminal device includes a touch screen terminal display and communication interface that communicates with a host server through a communication network, wherein the host server has access to database storing user accounts, and wherein the user mobile device includes a touch screen display and a wireless transceiver, the system comprising:
a terminal device transceiver associated with each terminal device, at least one of the terminal device transceiver and the mobile device transceiver configured to broadcast a beacon signal to acquire a response and establish a wireless communication link between the mobile device and the terminal device, and at least one of the terminal device transceiver and the mobile device transceiver configured to determine the signal strength of the wireless communication link established between the mobile device and terminal device;
a processor and associated memory device with each terminal device, the processor and associated memory configured to determine from the signal strength: a first range between the terminal device and mobile device indicative of a user mobile device pairing with the terminal device and upon successful pairing, a second range outside of the first range indicative of continued user mobile device presence at the terminal device which maintains continued pairing with the terminal device, and a third range outside of the second range indicative of the mobile device having left the terminal device whereupon the processor un-pairs the mobile device from the terminal device; and
the terminal device configured to access the user's account through the network and provide data to and/or from the user's account and the host server based upon the user's interaction with the terminal device during pairing.

2. The system of claim 1, wherein a location is determined from the signal strength of the mobile device using WiFi signals, Bluetooth signals, other wireless signals, or combinations thereof.

3. The system of claim 1, wherein the terminal device is a gaming machine that enables users to make wagers and engage in game play over time, wherein the gaming machine is configured to access the user's account and provide data indicative of amounts wagered while paired with the gaming machine.

4. The system of claim 1, wherein the terminal display presents a message confirming pairing of the mobile device with the terminal device.

5. The system of claim 4, wherein one or more of the terminal display and mobile device display an icon upon detection of the mobile device in the first range, and wherein a touch input at the icon enables pairing of the mobile device with the terminal device.

6. The system of claim 1, wherein one or more of the terminal device and mobile device are configured to receive security data, input by the user, that enables pairing of the mobile device with the terminal device.

7. The system of claim 6, wherein one or more of the terminal device and mobile device are configured to receive an identification number, input by the user, that enables pairing of the mobile device with the terminal device.

8. The system of claim 6, wherein the terminal device includes an optical scanner in communication with the processor, wherein the optical scanner scans a code displayed on the mobile device display to enable pairing of the mobile device with the terminal device.

9. The system of claim 1, wherein the mobile device has a unique address code, and wherein the host server uses the address code to access an account of the user.

10. The system of claim 1, wherein the terminal device is configured as a master device and broadcasts a beacon signal to detect a mobile device configured as a slave device.

11. The system of claim 1, wherein each terminal device is a gaming terminal, and wherein the system further comprises one or more servers configured to process funds transfer between the mobile devices and the gaming terminals while an individual mobile device is paired with an individual gaming terminal.

12. The system of claim 1, wherein the terminal device is an electronic gaming table having a plurality of player positions each including a primary wagering station at which a player enters wagers, the electronic gaming table configured to receive wagers from a back bettor's mobile device, upon a pairing of the back bettor's mobile device with the electronic gaming table.

13. A gaming machine including a touch screen video display and network link to communicate with a host server to provide data related to player activity at the gaming machine, the gaming machine comprising:
a communication device configured to broadcast a beacon signal to detect a mobile device transceiver, acquire a response to establish a communication link between the mobile device and the gaming machine, and determine the signal strength of the communication link;
a processor and associated memory device configured to determine from the signal strength: (1) a first range between the gaming machine and mobile device, indicative of a player pairing their mobile device with the gaming machine, (2) a second range outside of the first range, indicative of continued user mobile device presence at the gaming machine, which maintains continued pairing with the gaming machine, and (3) a third range outside of the second range, indicative of the mobile device having left the gaming machine, whereupon the processor un-pairs the mobile device from the gaming machine; and
wherein the gaming machine provides the data to the host server based upon the player's activity at the gaming machine while paired with the mobile device.

14. The gaming machine of claim 13, wherein a location is determined from the signal strength of the mobile device using WiFi signals, Bluetooth signals, other wireless signals, or combinations thereof.

15. The gaming machine of claim 13, wherein the gaming machine presents a message confirming pairing of the mobile device with the gaming machine.

16. The gaming machine of claim 13, wherein one or more of the gaming machine and mobile device display an icon upon detection of the mobile device in the first range, and wherein a touch input at the icon enables pairing of the mobile device with the gaming machine.

17. The gaming machine of claim 13, wherein one or more of the gaming machine and mobile device are configured to receive security data, input by the user, that enables pairing of the mobile device with the gaming machine.

18. The gaming machine of claim 17, wherein one or more of the gaming machine and mobile device are configured to receive an identification number, input by the user, that enables pairing of the mobile device with the gaming machine.

19. The gaming machine of claim 13, wherein the gaming machine is an electronic gaming table having a plurality of player positions each including a primary wagering station at which a player enters wagers, the electronic gaming table configured to receive wagers from a back bettor's mobile device, upon a pairing of the back bettor's mobile device with the electronic gaming table.

20. A method to pair a mobile device with a gaming machine and track interactions between the mobile device and the gaming machine while paired, the method comprising:
providing the gaming machine including a touch screen video display and network link to communicate with a host server to provide data related to player activity at the gaming machine;
broadcasting a beacon signal from a communication device to detect a mobile device transceiver;
acquiring a response to establish a communication link between the mobile device and the gaming machine;
determining the signal strength of the communication link;
determining from the signal strength, using a processor and associated memory device, a first range between the gaming machine and mobile device, indicative of a player pairing their mobile device with the gaming machine;
determining from the signal strength, using the processor and the associated memory device, a second range outside of the first range, indicative of continued user mobile device presence at the gaming machine, which maintains continued pairing with the gaming machine, and
determining from the signal strength, using the processor and the associated memory device, a third range outside of the second range, indicative of the mobile device having left the gaming machine, whereupon the processor un-pairs the mobile device from the gaming machine;
wherein the gaming machine provides the data to the host server based upon the player's activity at the gaming machine while paired with the mobile device.
